(19) United States
(12) Patent Application Publication
(10) Pub. No.: US 2021/0258265 A1
(43) Pub. Date: Aug. 19, 2021

(54) RESOURCE MANAGEMENT FOR COMPONENTS OF A VIRTUALIZED EXECUTION ENVIRONMENT

(71) Applicant: Intel Corporation, Santa Clara, CA (US)

(72) Inventors: Francesc GUIM BERNAT, Barcelona (ES); Karthik KUMAR, Chandler, AZ (US)

(21) Appl. No.: 17/169,073

(22) Filed: Feb. 5, 2021

Related U.S. Application Data
(60) Provisional application No. 63/130,671, filed on Dec. 26, 2020.

(51) Int. Cl. H04L 12/923; H04L 12/911; H04L 12/927; G06F 9/455; G06F 11/34

(52) U.S. Cl. CPC H04L 47/762; H04L 47/781; H04L 47/805; G06F 2009/45595; G06F 9/45558; G06F 11/3428; H04L 47/826

(57) ABSTRACT

Examples described herein relate to at least one processor that is to perform a command to build a container using multiple routines and allocate resources to at least one routine based on specification of a service level agreement (SLA) associated with each of the at least one routine. In some examples, the container is compatible with one or more of: Docker containers, Rkt containers, LXD containers, OpenVZ containers, Linux-VServer, Windows Containers, Hyper-V Containers, unikernels, or Java containers. In some examples, a service level is to specify one or more of: time to completion of a routine or resource allocation to the routine. In some examples, the resources include one or more of: cache allocation, memory allocation, memory bandwidth, network interface bandwidth, or accelerator allocation.

### RELATED APPLICATION

The present application claims the benefit of a priority date of U.S. provisional patent application Ser. No. 63/130,671, filed Dec. 26, 2020, the entire disclosure of which is incorporated herein by reference.

### DESCRIPTION

Cloud computing offers flexibility to select hardware, firmware, and/or software resources. Cloud native frameworks can use containers to deploy execution of applications, services, and workloads. Examples of cloud native frameworks include container-based technologies such as Kubernetes and Docker frameworks. For example, an artificial intelligence (AI) inference model can be built into a Docker container and run on a Kubernetes cluster using Microsoft® Azure infrastructure. For example, a Docker container can include operations bundled within an encapsulation. The entire software stack, including the libraries, are encapsulated within containers and a developer can create an environment that is portable and can be deployed in different computing environments, with a variety of options for selection of hardware and software resources, on-demand.

As an example, cloud stacks for graphics processing units (GPUs) are available. For example, a TensorRT Docker container can be used for execution on NVIDIA GPUs. In this example, the container encapsulates the libraries, executables and drivers of a TensorRT-based inference application that can be scaled to a training cluster for performance in the cloud or in the datacenter. To deploy or run the TensorRT Docker containers, the following cam occur: (1) Docker Engine loads the image into a container, (2) a user defines the runtime resources of the container by including additional flags and settings that are used with the command, and (3) GPUs are explicitly defined for the Docker container.

### BRIEF DESCRIPTION OF THE DRAWINGS

FIG. 1 is a simplified diagram of at least one embodiment of a data center for executing workloads with disaggregated resources.

FIG. 2 is a simplified diagram of at least one embodiment of a system that may be included in a data center.

FIG. 3 is a simplified block diagram of at least one embodiment of a top side of a node.

FIG. 4 is a simplified block diagram of at least one embodiment of a bottom side of a node.

FIG. 5 is a simplified block diagram of at least one embodiment of a compute node.

FIG. 6 is a simplified block diagram of at least one embodiment of an accelerator node usable in a data center.

FIG. 7 is a simplified block diagram of at least one embodiment of a storage node usable in a data center.

FIG. 8 is a simplified block diagram of at least one embodiment of a memory node usable in a data center.

FIG. 9 depicts a system for executing one or more workloads.

FIG. 10 depicts an example system.

FIG. 11 shows an example system.

FIG. 12 depicts an example of a Docker container image.

FIG. 13 depicts an example process in accordance with various embodiments.

FIG. 14 depicts a high-level architectural diagram.

FIG. 15 depicts an example system.

FIG. 16 depicts an example process.

FIG. 17 depicts an example computing system.

### DETAILED DESCRIPTION

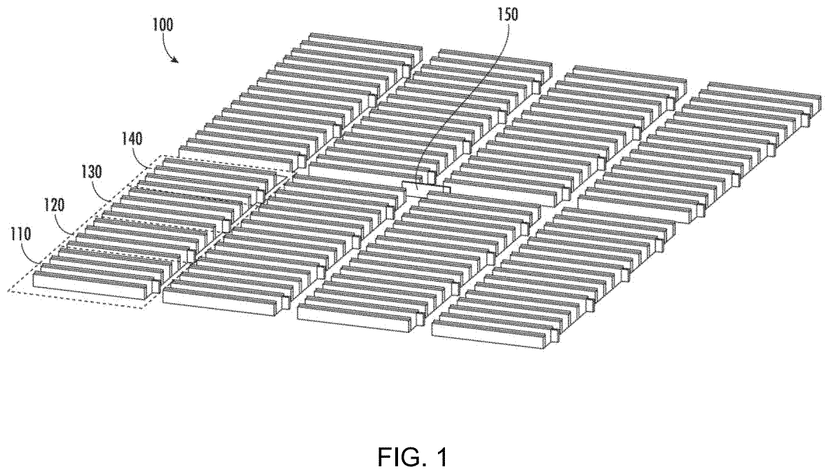

FIG. 1 depicts a data center in which disaggregated resources may cooperatively execute one or more workloads (e.g., applications on behalf of customers) that includes multiple systems 110, 70, 130, 80, a system being or including one or more rows of racks, racks, or trays. Of course, although data center 100 is shown with multiple systems, in some embodiments, the data center 100 may be embodied as a single system. As described in more detail herein, each rack houses multiple nodes, some of which may be equipped with one or more type of resources (e.g., memory devices, data storage devices, accelerator devices, general purpose processors, GPUs, xPUs, CPUs, field programmable gate arrays (FPGAs), or application-specific integrated circuits (ASICs)). Resources can be logically coupled or aggregated to form a composed node or composite node, which can act as, for example, a server to perform a job, workload or microservices.

Various examples described herein can perform an application composed of microservices, where each microservice runs in its own process and communicates using protocols (e.g., application program interface (API), a Hypertext Transfer Protocol (HTTP) resource API, message service, remote procedure calls (RPC), or Google RPC (gRPC)). Microservices can be independently deployed using centralized management of these services. The management system may be written in different programming languages and use different data storage technologies. A microservice can be characterized by one or more of: use of fine-grained interfaces (to independently deployable services), polyglot programming (e.g., code written in multiple languages to capture additional functionality and efficiency not available in a single language), or lightweight container or virtual machine deployment, and decentralized continuous microservice delivery.

In the illustrative embodiment, the nodes in each system 110, 70, 130, 80 are connected to multiple system switches (e.g., switches that route data communications to and from nodes within the system). Switches can be positioned top of rack (TOR), end of row (EOR), middle of rack (MOR), or a position in a rack or row. The system switches, in turn, connect with spine switches 90 that switch communications among systems (e.g., the systems 110, 70, 130, 80) in the data center 100. In some embodiments, the nodes may be connected with a fabric using standards described herein or proprietary standards. In other embodiments, the nodes may be connected with other fabrics, such as InfiniB and or Ethernet. As described in more detail herein, resources within nodes in the data center 100 may be allocated to a group (referred to herein as a “managed node”) containing resources from one or more nodes to be collectively utilized in the execution of a workload. The workload can execute as if the resources belonging to the managed node were located on the same node. The resources in a managed node may belong to nodes belonging to different racks, and even to different systems 110, 70, 130, 80. As such, some resources of a single node may be allocated to one managed node while other resources of the same node are allocated to a different managed node (e.g., one processor assigned to one managed node and another processor of the same node assigned to a different managed node).

A data center comprising disaggregated resources, such as data center 100, can be used in a wide variety of contexts, such as enterprise, government, cloud service provider, and communications service provider (e.g., Telcos), as well in a wide variety of sizes, from cloud service provider mega-data center or hyper-scaled data centers that can consume over 60,000 sq. ft. to single- or multi-rack installations for use in base stations.

The disaggregation of resources to nodes comprised predominantly of a single type of resource (e.g., compute nodes comprising primarily compute resources, memory nodes containing primarily memory resources), and the selective allocation and deallocation of the disaggregated resources to form a managed node assigned to execute a workload improves the operation and resource usage of the data center 100 relative to typical data centers comprised of hyperconverged servers containing compute, memory, storage and perhaps additional resources in a single chassis. For example, because nodes predominantly contain resources of a particular type, resources of a given type can be upgraded independently of other resources. Additionally, because different resources types (processors, storage, accelerators, etc.) typically have different refresh rates, greater resource utilization and reduced total cost of ownership may be achieved. For example, a data center operator can upgrade the processors throughout their facility by only swapping out the compute nodes. In such a case, accelerator and storage resources may not be contemporaneously upgraded and, rather, may be allowed to continue operating until those resources are scheduled for their own refresh. Resource utilization may also increase. For example, if managed nodes are composed based on requirements of the workloads that will be running on them, resources within a node are more likely to be fully utilized. Such utilization may allow for more managed nodes to run in a data center with a given set of resources, or for a data center expected to run a given set of workloads, to be built using fewer resources.

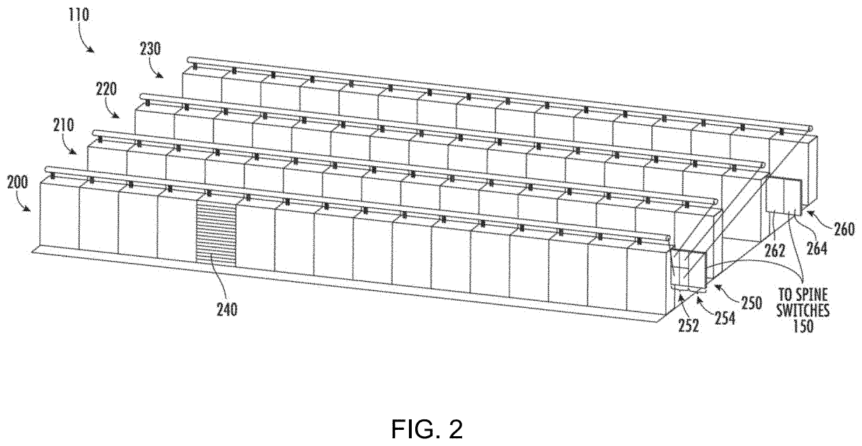

FIG. 2 depicts a system. A system can include a set of rows 200, 210, 220, 230 of racks 240. Each rack 240 may house multiple nodes (e.g., sixteen nodes) and provide power and data connections to the housed nodes, as described in more detail herein. In the illustrative embodiment, the racks in each row 200, 210, 220, 230 are connected to multiple system switches 250, 260. The system switch 250 includes a set of ports 252 to which the nodes of the racks of the system 110 are connected and another set of ports 254 that connect the system 110 to the spine switches 90 to provide connectivity to other systems in the data center 100. Similarly, the system switch 260 includes a set of ports 262 to which the nodes of the racks of the system 110 are connected and a set of ports 264 that connect the system 110 to the spine switches 90. As such, the use of the pair of switches 250, 260 provides an amount of redundancy to the system 110. For example, if either of the switches 250, 260 fails, the nodes in the system 110 may still maintain data communication with the remainder of the data center 100 (e.g., nodes of other systems) through the other switch 250, 260. Furthermore, in the illustrative embodiment, the switches 90, 250, 260 may be embodied as dual-mode optical switches, capable of routing both Ethernet protocol communications carrying Internet Protocol (IP) packets and communications according to a second, high-performance link-layer protocol (e.g., PCI Express or Compute Express Link) via optical signaling media of an optical fabric.

It should be appreciated that each of the other systems 70, 130, 80 (as well as additional systems of the data center 100) may be similarly structured as, and have components similar to, the system 110 shown in and described in regard to FIG. 2 (e.g., each system may have rows of racks housing multiple nodes as described above). Additionally, while two system switches 250, 260 are shown, it should be understood that in other embodiments, each system 110, 70, 130, 80 may be connected to a different number of system switches, providing even more failover capacity. Of course, in other embodiments, systems may be arranged differently than the rows-of-racks configuration shown in FIGS. 1-2. For example, a system may be embodied as multiple sets of racks in which each set of racks is arranged radially, e.g., the racks are equidistant from a center switch.

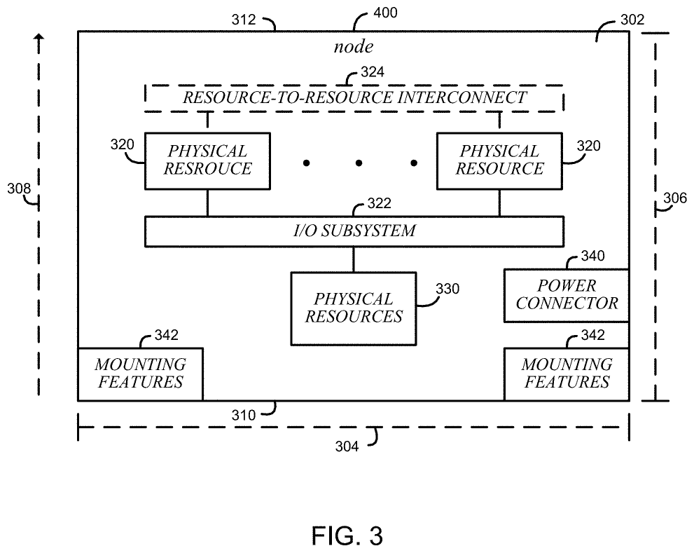

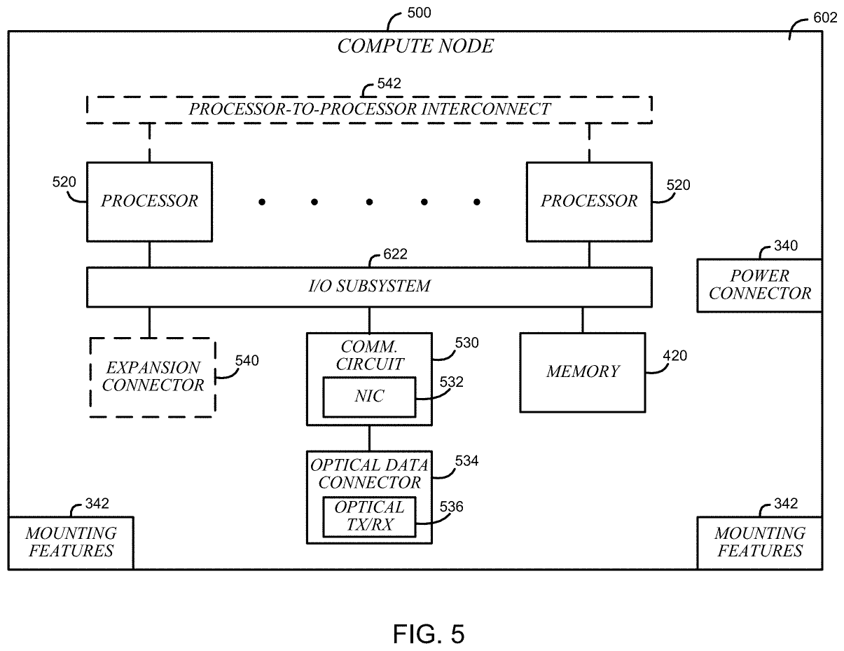

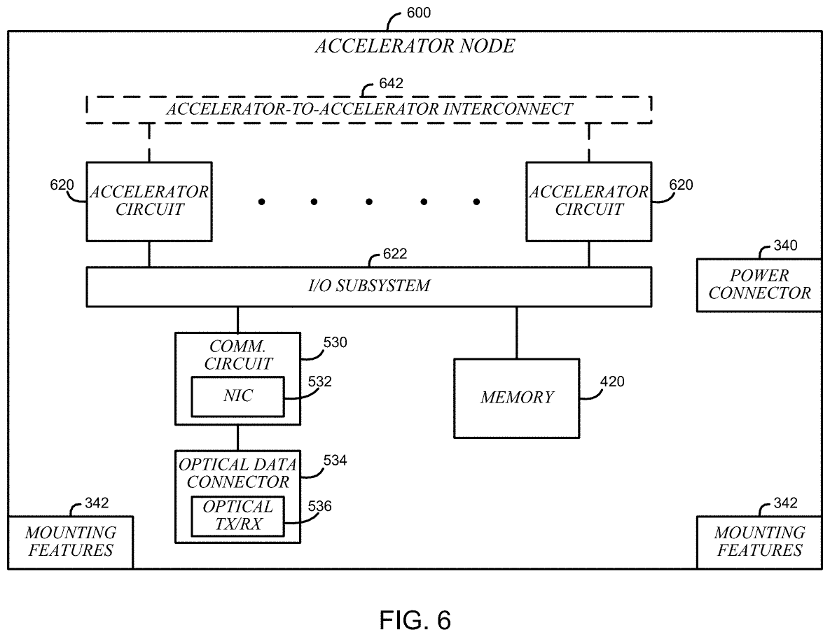

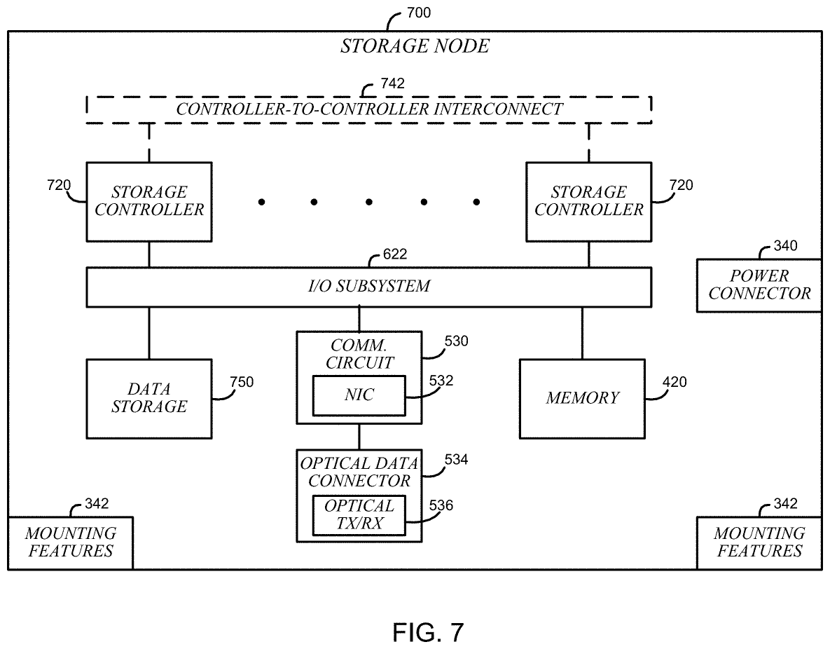

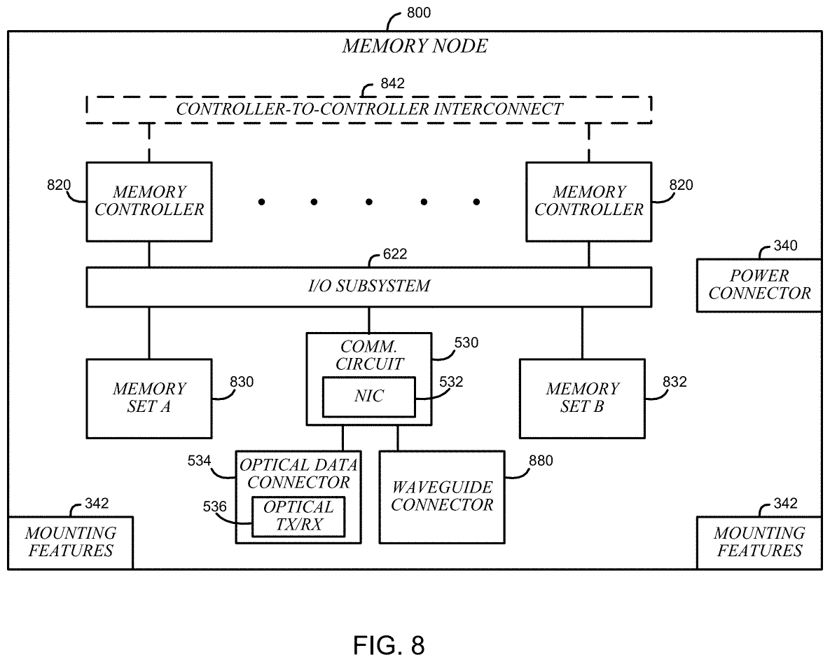

Referring now to FIG. 3, node 400, in the illustrative embodiment, is configured to be mounted in a corresponding rack 240 of the data center 100 as discussed above. In some embodiments, each node 400 may be optimized or otherwise configured for performing particular tasks, such as compute tasks, acceleration tasks, data storage tasks, etc. For example, the node 400 may be embodied as a compute node 500 as discussed below in regard to FIG. 5, an accelerator node 600 as discussed below in regard to FIG. 6, a storage node 700 as discussed below in regard to FIG. 7, or as a node optimized or otherwise configured to perform other specialized tasks, such as a memory node 800, discussed below in regard to FIG. 8.

As discussed above, the illustrative node 400 includes a circuit board substrate 302, which supports various physical resources (e.g., electrical components) mounted thereon. As discussed above, the illustrative node 400 includes one or more physical resources 320 mounted to circuit board substrate 302. Although two physical resources 320 are shown in FIG. 3, it should be appreciated that the node 400 may include one, two, or more physical resources 320 in other embodiments. The physical resources 320 may be embodied as any type of processor, controller, or other compute circuit capable of performing various tasks such as compute functions and/or controlling the functions of the node 400 depending on, for example, the type or intended functionality of the node 400. For example, as discussed in more detail below, the physical resources 320 may be embodied as high-performance processors in embodiments in which the node 400 is embodied as a compute node, as accelerator co-processors or circuits in embodiments in which the node 400 is embodied as an accelerator node, storage controllers in embodiments in which the node 400 is embodied as a storage node, or a set of memory devices in embodiments in which the node 400 is embodied as a memory node.

The node 400 also includes one or more additional physical resources 330 mounted to circuit board substrate 302. In the illustrative embodiment, the additional physical resources include a network interface controller (NIC) as discussed in more detail below. Of course, depending on the type and functionality of the node 400, the physical resources 330 may include additional or other electrical components, circuits, and/or devices in other embodiments.

The physical resources 320 can be communicatively coupled to the physical resources 330 via an input/output (I/O) subsystem 322. The I/O subsystem 322 may be embodied as circuitry and/or components to facilitate input/output operations with the physical resources 320, the physical resources 330, and/or other components of the node 400. For example, the I/O subsystem 322 may be embodied as, or otherwise include, memory controller hubs, input/output control hubs, integrated sensor hubs, firmware devices, communication links (e.g., point-to-point links, bus links, wires, cables, waveguides, light guides, printed circuit board traces, etc.), and/or other components and subsystems to facilitate the input/output operations. In the illustrative embodiment, the I/O subsystem 322 is embodied as, or otherwise includes, a double data rate 4 (DDR4) data bus or a DDR5 data bus.

In some embodiments, the node 400 may also include a resource-to-resource interconnect 324. The resource-to-resource interconnect 324 may be embodied as any type of communication interconnect capable of facilitating resource-to-resource communications. In the illustrative embodiment, the resource-to-resource interconnect 324 is embodied as a high-speed point-to-point interconnect (e.g., faster than the I/O subsystem 322). For example, the resource-to-resource interconnect 324 may be embodied as a QuickPath Interconnect (QPI), an UltraPath Interconnect (UPI), PCI express (PCIe), or other high-speed point-to-point interconnect dedicated to resource-to-resource communications.

The node 400 also includes a power connector 340 configured to mate with a corresponding power connector of the rack 240 when the node 400 is mounted in the corresponding rack 240. The node 400 receives power from a power supply of the rack 240 via the power connector 340 to supply power to the various electrical components of the node 400. In some examples, the node 400 includes local power supply (e.g., an on-board power supply) to provide power to the electrical components of the node 400. In some examples, the node 400 does not include any local power supply (e.g., an on-board power supply) to provide power to the electrical components of the node 400. The exclusion of a local or on-board power supply facilitates the reduction in the overall footprint of the circuit board substrate 302, which may increase the thermal cooling characteristics of the various electrical components mounted on the circuit board substrate 302 as discussed above. In some embodiments, voltage regulators are placed on circuit board substrate 302 directly opposite of the processors 520 (see FIG. 5), and power is routed from the voltage regulators to the processors 520 by vias extending through the circuit board substrate 302. Such a configuration provides an increased thermal budget, additional current and/or voltage, and better voltage control relative to typical printed circuit boards in which processor power is delivered from a voltage regulator, in part, by printed circuit traces.

In some embodiments, the node 400 may also include mounting features 342 configured to mate with a mounting arm, or other structure, of a robot to facilitate the placement of the node 300 in a rack 240 by the robot. The mounting features 342 may be embodied as any type of physical structures that allow the robot to grasp the node 400 without damaging the circuit board substrate 302 or the electrical components mounted thereto. For example, in some embodiments, the mounting features 342 may be embodied as non-conductive pads attached to the circuit board substrate 302. In other embodiments, the mounting features may be embodied as brackets, braces, or other similar structures attached to the circuit board substrate 302. The particular number, shape, size, and/or make-up of the mounting feature 342 may depend on the design of the robot configured to manage the node 400.

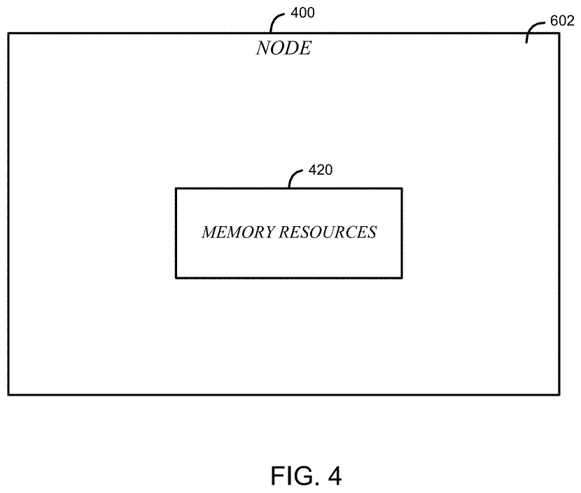

Referring now to FIG. 4, in addition to the physical resources 330 mounted on circuit board substrate 302, the node 400 also includes one or more memory devices 420 mounted to circuit board substrate 302. That is, the circuit board substrate 302 can be embodied as a double-sided circuit board. The physical resources 320 can be communicatively coupled to memory devices 420 via the I/O subsystem 322. For example, the physical resources 320 and the memory devices 420 may be communicatively coupled by one or more vias extending through the circuit board substrate 302. A physical resource 320 may be communicatively coupled to a different set of one or more memory devices 420 in some embodiments. Alternatively, in other embodiments, each physical resource 320 may be communicatively coupled to each memory device 420.

The memory devices 420 may be embodied as any type of memory device capable of storing data for the physical resources 320 during operation of the node 400, such as any type of volatile (e.g., dynamic random access memory (DRAM), etc.) or non-volatile memory. Volatile memory may be a storage medium that requires power to maintain the state of data stored by the medium. Non-limiting examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces.

In one embodiment, the memory device is a block addressable memory device, such as those based on NAND or NOR technologies, for example, multi-threshold level NAND flash memory and NOR flash memory. A block can be any size such as but not limited to 2 KB, 4 KB, 5 KB, and so forth. A memory device may also include next-generation nonvolatile devices, such as Intel Optane® memory or other byte addressable write-in-place nonvolatile memory devices (e.g., memory devices that use chalcogenide glass), multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of one or more of the above, or other memory. The memory device may refer to the die itself and/or to a packaged memory product. In some embodiments, the memory device may comprise a transistor-less stackable cross point architecture in which memory cells sit at the intersection of word lines and bit lines and are individually addressable and in which bit storage is based on a change in bulk resistance.

Referring now to FIG. 5, in some embodiments, the node 400 may be embodied as a compute node 500. The compute node 500 can be configured to perform compute tasks. Of course, as discussed above, the compute node 500 may rely on other nodes, such as acceleration nodes and/or storage nodes, to perform compute tasks.

In the illustrative compute node 500, the physical resources 320 are embodied as processors 520. Although only two processors 520 are shown in FIG. 5, it should be appreciated that the compute node 500 may include additional processors 520 in other embodiments. Illustratively, the processors 520 are embodied as high-performance processors 520 and may be configured to operate at a relatively high power rating.

In some embodiments, the compute node 500 may also include a processor-to-processor interconnect 542. Processor-to-processor interconnect 542 may be embodied as any type of communication interconnect capable of facilitating processor-to-processor interconnect 542 communications. In the illustrative embodiment, the processor-to-processor interconnect 542 is embodied as a high-speed point-to-point interconnect (e.g., faster than the I/O subsystem 322). For example, the processor-to-processor interconnect 542 may be embodied as a QuickPath Interconnect (QPI), an UltraPath Interconnect (UPI), or other high-speed point-to-point interconnect dedicated to processor-to-processor communications (e.g., PCIe or CXL).

The compute node 500 also includes a communication circuit 530. The illustrative communication circuit 530 includes a network interface controller (NIC) 532, which may also be referred to as a host fabric interface (HFI). The NIC 532 may be embodied as, or otherwise include, any type of integrated circuit, discrete circuits, controller chips, chipsets, add-in-boards, daughtercards, network interface cards, or other devices that may be used by the compute node 500 to connect with another compute device (e.g., with other nodes 400). In some embodiments, the NIC 532 may be embodied as part of a system-on-a-chip (SoC) that includes one or more processors, or included on a multichip package that also contains one or more processors. In some embodiments, the NIC 532 may include a local processor (not shown) and/or a local memory (not shown) that are both local to the NIC 532. In such embodiments, the local processor of the NIC 532 may be capable of performing one or more of the functions of the processors 520. Additionally or alternatively, in such embodiments, the local memory of the NIC 532 may be integrated into one or more components of the compute node at the board level, socket level, chip level, and/or other levels. In some examples, a network interface includes a network interface controller or a network interface card. In some examples, a network interface can include one or more of a network interface controller (NIC) 532, a host fabric interface (HFI), a host bus adapter (HBA), network interface connected to a bus or connection (e.g., PCIe, CXL, DDR, and so forth). In some examples, a network interface can be part of a switch or a system-on-chip (SoC).

Some examples of a NIC are part of an Infrastructure Processing Unit (IPU) or data processing unit (DPU) or utilized by an IPU or DPU. An IPU or DPU can include a network interface, memory devices, and one or more programmable or fixed function processors (e.g., CPU or XPU) to perform offload of operations that could have been performed by a host CPU or XPU or remote CPU or XPU. In some examples, the IPU or DPU can perform virtual switch operations, manage storage transactions (e.g., compression, cryptography, virtualization), and manage operations performed on other IPUs, DPUs, servers, or devices.

The communication circuit 530 is communicatively coupled to an optical data connector 534. The optical data connector 534 is configured to mate with a corresponding optical data connector of a rack when the compute node 500 is mounted in the rack. Illustratively, the optical data connector 534 includes a plurality of optical fibers which lead from a mating surface of the optical data connector 534 to an optical transceiver 536. The optical transceiver 536 is configured to convert incoming optical signals from the rack-side optical data connector to electrical signals and to convert electrical signals to outgoing optical signals to the rack-side optical data connector. Although shown as forming part of the optical data connector 534 in the illustrative embodiment, the optical transceiver 536 may form a portion of the communication circuit 530 in other embodiments.

In some embodiments, the compute node 500 may also include an expansion connector 540. In such embodiments, the expansion connector 540 is configured to mate with a corresponding connector of an expansion circuit board substrate to provide additional physical resources to the compute node 500. The additional physical resources may be used, for example, by the processors 520 during operation of the compute node 500. The expansion circuit board substrate may be substantially similar to the circuit board substrate 302 discussed above and may include various electrical components mounted thereto. The particular electrical components mounted to the expansion circuit board substrate may depend on the intended functionality of the expansion circuit board substrate. For example, the expansion circuit board substrate may provide additional compute resources, memory resources, and/or storage resources. As such, the additional physical resources of the expansion circuit board substrate may include, but is not limited to, processors, memory devices, storage devices, and/or accelerator circuits including, for example, field programmable gate arrays (FPGA), application-specific integrated circuits (ASICs), security co-processors, graphics processing units (GPUs), machine learning circuits, or other specialized processors, controllers, devices, and/or circuits. Note that reference to GPU or CPU herein can in addition or alternatively refer to an XPU or xPU. An xPU can include one or more of: a GPU, ASIC, FPGA, or accelerator device.

Referring now to FIG. 6, in some embodiments, the node 400 may be embodied as an accelerator node 600. The accelerator node 600 is configured to perform specialized compute tasks, such as machine learning, encryption, hashing, or other computational-intensive task. In some embodiments, for example, a compute node 500 may offload tasks to the accelerator node 600 during operation. The accelerator node 600 includes various components similar to components of the node 400 and/or compute node 500, which have been identified in FIG. 6 using the same reference numbers.

In the illustrative accelerator node 600, the physical resources 320 are embodied as accelerator circuits 620. Although only two accelerator circuits 620 are shown in FIG. 6, it should be appreciated that the accelerator node 600 may include additional accelerator circuits 620 in other embodiments. The accelerator circuits 620 may be embodied as any type of processor, co-processor, compute circuit, or other device capable of performing compute or processing operations. For example, the accelerator circuits 620 may be embodied as, for example, central processing units, cores, field programmable gate arrays (FPGA), application-specific integrated circuits (ASICs), programmable control logic (PCL), security co-processors, graphics processing units (GPUs), neuromorphic processor units, quantum computers, machine learning circuits, programmable processing pipeline (e.g., programmable by P4, C, Python, Broadcom Network Programming Language (NPL), or x86 compatible executable binaries or other executable binaries). Processors, FPGAs, other specialized processors, controllers, devices, and/or circuits can be used utilized for packet processing or packet modification. Ternary content-addressable memory (TCAM) can be used for parallel match-action or look-up operations on packet header content.

In some embodiments, the accelerator node 600 may also include an accelerator-to-accelerator interconnect 642. Similar to the resource-to-resource interconnect 324 of the node 300 discussed above, the accelerator-to-accelerator interconnect 642 may be embodied as any type of communication interconnect capable of facilitating accelerator-to-accelerator communications. In the illustrative embodiment, the accelerator-to-accelerator interconnect 642 is embodied as a high-speed point-to-point interconnect (e.g., faster than the I/O subsystem 322). For example, the accelerator-to-accelerator interconnect 642 may be embodied as a QuickPath Interconnect (QPI), an UltraPath Interconnect (UPI), or other high-speed point-to-point interconnect dedicated to processor-to-processor communications. In some embodiments, the accelerator circuits 620 may be daisy-chained with a primary accelerator circuit 620 connected to the NIC 532 and memory 420 through the I/O subsystem 322 and a secondary accelerator circuit 620 connected to the NIC 532 and memory 420 through a primary accelerator circuit 620.

Referring now to FIG. 7, in some embodiments, the node 400 may be embodied as a storage node 700. The storage node 700 is configured, to store data in a data storage 750 local to the storage node 700. For example, during operation, a compute node 500 or an accelerator node 600 may store and retrieve data from the data storage 750 of the storage node 700. The storage node 700 includes various components similar to components of the node 400 and/or the compute node 500, which have been identified in FIG. 7 using the same reference numbers.

In the illustrative storage node 700, the physical resources 320 are embodied as storage controllers 720. Although only two storage controllers 720 are shown in FIG. 7, it should be appreciated that the storage node 700 may include additional storage controllers 720 in other embodiments. The storage controllers 720 may be embodied as any type of processor, controller, or control circuit capable of controlling the storage and retrieval of data into the data storage 750 based on requests received via the communication circuit 530. In the illustrative embodiment, the storage controllers 720 are embodied as relatively low-power processors or controllers.

In some embodiments, the storage node 700 may also include a controller-to-controller interconnect 742. Similar to the resource-to-resource interconnect 324 of the node 400 discussed above, the controller-to-controller interconnect 742 may be embodied as any type of communication interconnect capable of facilitating controller-to-controller communications. In the illustrative embodiment, the controller-to-controller interconnect 742 is embodied as a high-speed point-to-point interconnect (e.g., faster than the I/O subsystem 322). For example, the controller-to-controller interconnect 742 may be embodied as a QuickPath Interconnect (QPI), an UltraPath Interconnect (UPI), or other high-speed point-to-point interconnect dedicated to processor-to-processor communications.

Referring now to FIG. 8, in some embodiments, the node 400 may be embodied as a memory node 800. The memory node 800 is configured to provide other nodes 400 (e.g., compute nodes 500, accelerator nodes 600, etc.) with access to a pool of memory (e.g., in two or more sets 830, 832 of memory devices 420) local to the storage node 700. For example, during operation, a compute node 500 or an accelerator node 600 may remotely write to and/or read from one or more of the memory sets 830, 832 of the memory node 800 using a logical address space that maps to physical addresses in the memory sets 830, 832.

In the illustrative memory node 800, the physical resources 320 are embodied as memory controllers 820. Although only two memory controllers 820 are shown in FIG. 8, it should be appreciated that the memory node 800 may include additional memory controllers 820 in other embodiments. The memory controllers 820 may be embodied as any type of processor, controller, or control circuit capable of controlling the writing and reading of data into the memory sets 830, 832 based on requests received via the communication circuit 530. In the illustrative embodiment, each memory controller 820 is connected to a corresponding memory set 830, 832 to write to and read from memory devices 420 within the corresponding memory set 830, 832 and enforce a permissions (e.g., read, write, etc.) associated with node 400 that has sent a request to the memory node 800 to perform a memory access operation (e.g., read or write).

In some embodiments, the memory node 800 may also include a controller-to-controller interconnect 842. Similar to the resource-to-resource interconnect 324 of the node 400 discussed above, the controller-to-controller interconnect 842 may be embodied as any type of communication interconnect capable of facilitating controller-to-controller communications. In the illustrative embodiment, the controller-to-controller interconnect 842 is embodied as a high-speed point-to-point interconnect (e.g., faster than the I/O subsystem 322). For example, the controller-to-controller interconnect 842 may be embodied as a QuickPath Interconnect (QPI), an UltraPath Interconnect (UPI), or other high-speed point-to-point interconnect dedicated to processor-to-processor communications. As such, in some embodiments, a memory controller 820 may access, through the controller-to-controller interconnect 842, memory that is within the memory set 832 associated with another memory controller 820. In some embodiments, a scalable memory controller is made of multiple smaller memory controllers, referred to herein as “chiplets”, on a memory node (e.g., the memory node 800). The chiplets may be interconnected (e.g., using EMIB (Embedded Multi-Die Interconnect Bridge)). The combined chiplet memory controller may scale up to a relatively large number of memory controllers and I/O ports, (e.g., up to 16 memory channels). In some embodiments, the memory controllers 820 may implement a memory interleave (e.g., one memory address is mapped to the memory set 830, the next memory address is mapped to the memory set 832, and the third address is mapped to the memory set 830, etc.). The interleaving may be managed within the memory controllers 820, or from CPU sockets (e.g., of the compute node 500) across network links to the memory sets 830, 832, and may improve the latency associated with performing memory access operations as compared to accessing contiguous memory addresses from the same memory device.

Further, in some embodiments, the memory node 800 may be connected to one or more other nodes 400 (e.g., in the same rack 240 or an adjacent rack 240) through a waveguide, using the waveguide connector 880. In the illustrative embodiment, the waveguides are 64 millimeter waveguides that provide 16 Rx (e.g., receive) lanes and 16 Tx (e.g., transmit) lanes. Each lane, in the illustrative embodiment, is either 16 GHz or 32 GHz. In other embodiments, the frequencies may be different. Using a waveguide may provide high throughput access to the memory pool (e.g., the memory sets 830, 832) to another node (e.g., a node 400 in the same rack 240 or an adjacent rack 240 as the memory node 800) without adding to the load on the optical data connector 534.

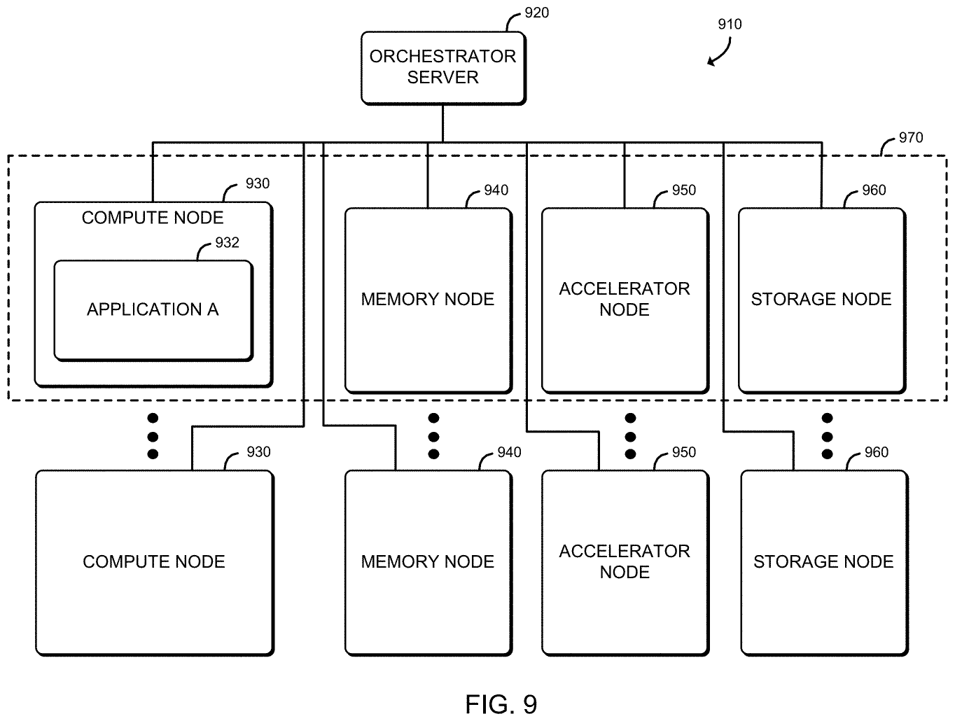

Referring now to FIG. 9, a system for executing one or more workloads (e.g., applications) may be implemented. In the illustrative embodiment, the system 910 includes an orchestrator server 920, which may be embodied as a managed node comprising a compute device (e.g., a processor 520 on a compute node 500) executing management software (e.g., a cloud operating environment, such as OpenStack) that is communicatively coupled to multiple nodes 400 including a large number of compute nodes 930 (e.g., each similar to the compute node 500), memory nodes 940 (e.g., each similar to the memory node 800), accelerator nodes 950 (e.g., each similar to the memory node 600), and storage nodes 960 (e.g., each similar to the storage node 700). One or more of the nodes 930, 940, 950, 960 may be grouped into a managed node 970, such as by the orchestrator server 920, to collectively perform a workload (e.g., an application 932 executed in a virtual machine or in a container).

The managed node 970 may be embodied as an assembly of physical resources 320, such as processors 520, memory resources 420, accelerator circuits 620, or data storage 750, from the same or different nodes 400. Further, the managed node may be established, defined, or “spun up” by the orchestrator server 920 at the time a workload is to be assigned to the managed node or at a time, and may exist regardless of whether a workload is presently assigned to the managed node. In the illustrative embodiment, the orchestrator server 920 may selectively allocate and/or deallocate physical resources 320 from the nodes 400 and/or add or remove one or more nodes 400 from the managed node 970 as a function of quality of service (QoS) targets (e.g., a target throughput, a target latency, a target number instructions per second, etc.) associated with a service level agreement or class of service (COS or CLOS) for the workload (e.g., the application 932). In doing so, the orchestrator server 920 may receive telemetry data indicative of performance conditions (e.g., throughput, latency, instructions per second, etc.) in each node 400 of the managed node 970 and compare the telemetry data to the quality of service targets to determine whether the quality of service targets are being satisfied. The orchestrator server 920 may additionally determine whether one or more physical resources may be deallocated from the managed node 970 while still satisfying the QoS targets, thereby freeing up those physical resources for use in another managed node (e.g., to execute a different workload). Alternatively, if the QoS targets are not presently satisfied, the orchestrator server 920 may determine to dynamically allocate additional physical resources to assist in the execution of the workload (e.g., the application 932) while the workload is executing. Similarly, the orchestrator server 920 may determine to dynamically deallocate physical resources from a managed node if the orchestrator server 920 determines that deallocating the physical resource would result in QoS targets still being met.

Additionally, in some embodiments, the orchestrator server 920 may identify trends in the resource utilization of the workload (e.g., the application 932), such as by identifying phases of execution (e.g., time periods in which different operations, each having different resource utilizations characteristics, are performed) of the workload (e.g., the application 932) and pre-emptively identifying available resources in the data center and allocating them to the managed node 970 (e.g., within a predefined time period of the associated phase beginning). In some embodiments, the orchestrator server 920 may model performance based on various latencies and a distribution scheme to place workloads among compute nodes and other resources (e.g., accelerator nodes, memory nodes, storage nodes) in the data center. For example, the orchestrator server 920 may utilize a model that accounts for the performance of resources on the nodes 400 (e.g., FPGA performance, memory access latency, etc.) and the performance (e.g., congestion, latency, bandwidth) of the path through the network to the resource (e.g., FPGA). As such, the orchestrator server 920 may determine which resource(s) should be used with which workloads based on the total latency associated with each potential resource available in the data center 100 (e.g., the latency associated with the performance of the resource itself in addition to the latency associated with the path through the network between the compute node executing the workload and the node 400 on which the resource is located).

In some embodiments, the orchestrator server 920 may generate a map of heat generation in the data center 100 using telemetry data (e.g., temperatures, fan speeds, etc.) reported from the nodes 400 and allocate resources to managed nodes as a function of the map of heat generation and predicted heat generation associated with different workloads, to maintain a target temperature and heat distribution in the data center 100. Additionally or alternatively, in some embodiments, the orchestrator server 920 may organize received telemetry data into a hierarchical model that is indicative of a relationship between the managed nodes (e.g., a spatial relationship such as the physical locations of the resources of the managed nodes within the data center 100 and/or a functional relationship, such as groupings of the managed nodes by the customers the managed nodes provide services for, the types of functions typically performed by the managed nodes, managed nodes that typically share or exchange workloads among each other, etc.). Based on differences in the physical locations and resources in the managed nodes, a given workload may exhibit different resource utilizations (e.g., cause a different internal temperature, use a different percentage of processor or memory capacity) across the resources of different managed nodes. The orchestrator server 920 may determine the differences based on the telemetry data stored in the hierarchical model and factor the differences into a prediction of future resource utilization of a workload if the workload is reassigned from one managed node to another managed node, to accurately balance resource utilization in the data center 100. In some embodiments, the orchestrator server 920 may identify patterns in resource utilization phases of the workloads and use the patterns to predict future resource utilization of the workloads.

To reduce the computational load on the orchestrator server 920 and the data transfer load on the network, in some embodiments, the orchestrator server 920 may send self-test information to the nodes 400 to enable each node 400 to locally (e.g., on the node 400) determine whether telemetry data generated by the node 400 satisfies one or more conditions (e.g., an available capacity that satisfies a predefined threshold, a temperature that satisfies a predefined threshold, etc.). Each node 400 may then report back a simplified result (e.g., yes or no) to the orchestrator server 920, which the orchestrator server 920 may utilize in determining the allocation of resources to managed nodes.

Embodiments described herein can be used in a data center or disaggregated composite nodes. The techniques described herein can apply to both disaggregated and traditional server architectures. A traditional server can include a CPU, XPU, one or more memory devices, networking communicatively coupled to one or more circuit boards within a server.

### Edge Network

Edge computing, at a general level, refers to the implementation, coordination, and use of computing and resources at locations closer to the “edge” or collection of “edges” of the network. The purpose of this arrangement is to improve total cost of ownership, reduce application and network latency, reduce network backhaul traffic and associated energy consumption, improve service capabilities, and improve compliance with security or data privacy requirements (especially as compared to conventional cloud computing). Components that can perform edge computing operations (“edge nodes”) can reside in whatever location needed by the system architecture or ad hoc service (e.g., in a high performance compute data center or cloud installation; a designated edge node server, an enterprise server, a roadside server, a telecom central office; or a local or peer at-the-edge device being served consuming edge services).

Applications that have been adapted for edge computing include but are not limited to virtualization of traditional network functions (e.g., to operate telecommunications or Internet services) and the introduction of next-generation features and services (e.g., to support 5G network services). Use-cases that utilize edge computing include connected self-driving cars, surveillance, Internet of Things (IoT) device data analytics, video encoding and analytics, location aware services, device sensing in Smart Cities, among many other network and compute intensive services.

Edge computing may, in some scenarios, offer or host a cloud-like distributed service, to offer orchestration and management for applications and coordinated service instances among many types of storage and compute resources. Edge computing is also expected to be closely integrated with existing use cases and technology developed for IoT and Fog/distributed networking configurations, as endpoint devices, clients, and gateways attempt to access network resources and applications at locations closer to the edge of the network.

The following embodiments generally relate to data processing, service management, resource allocation, compute management, network communication, application partitioning, and communication system implementations, and in particular, to techniques and configurations for adapting various edge computing devices and entities to dynamically support multiple entities (e.g., multiple tenants, users, stakeholders, service instances, applications, etc.) in a distributed edge computing environment.

In the following description, methods, configurations, and related apparatuses are disclosed for various improvements to the configuration and functional capabilities of an edge computing architecture and an implementing edge computing system. These improvements may benefit a variety of use cases, especially those involving multiple stakeholders of the edge computing system—whether in the form of multiple users of a system, multiple tenants on a system, multiple devices or user equipment interacting with a system, multiple services being offered from a system, multiple resources being available or managed within a system, multiple forms of network access being exposed for a system, multiple locations of operation for a system, and the like. Such multi-dimensional aspects and considerations are generally referred to herein as “multi-entity” constraints, with specific discussion of resources managed or orchestrated in multi-tenant and multi-service edge computing configurations.

With the illustrative edge networking systems described below, computing and storage resources are moved closer to the edge of the network (e.g., closer to the clients, endpoint devices, or “things”). By moving the computing and storage resources closer to the device producing or using the data, various latency, compliance, and/or monetary or resource cost constraints may be achievable relative to a standard networked (e.g., cloud computing) system. To do so, in some examples, pools of compute, memory, and/or storage resources may be located in, or otherwise equipped with, local servers, routers, and/or other network equipment. Such local resources facilitate the satisfying of constraints placed on the system. For example, the local compute and storage resources allow an edge system to perform computations in real-time or near real-time, which may be a consideration in low latency user-cases such as autonomous driving, video surveillance, and mobile media consumption. Additionally, these resources will benefit from service management in an edge system which provides the ability to scale and achieve local service level agreements (SLAs) or service level objectives (SLOs), manage tiered service requirements, and enable local features and functions on a temporary or permanent basis.

A pool can include a device on a same chassis or different physically dispersed devices on different chassis or different racks. A resource pool can include homogeneous processors, homogeneous processors, and/or a memory pool.

An illustrative edge computing system may support and/or provide various services to endpoint devices (e.g., client user equipment (UEs)), each of which may have different requirements or constraints. For example, some services may have priority or quality-of-service (QoS) constraints (e.g., traffic data for autonomous vehicles may have a higher priority than temperature sensor data), reliability and resiliency (e.g., traffic data may require mission-critical reliability, while temperature data may be allowed some error variance), as well as power, cooling, and form-factor constraints. These and other technical constraints may offer significant complexity and technical challenges when applied in the multi-stakeholder setting.

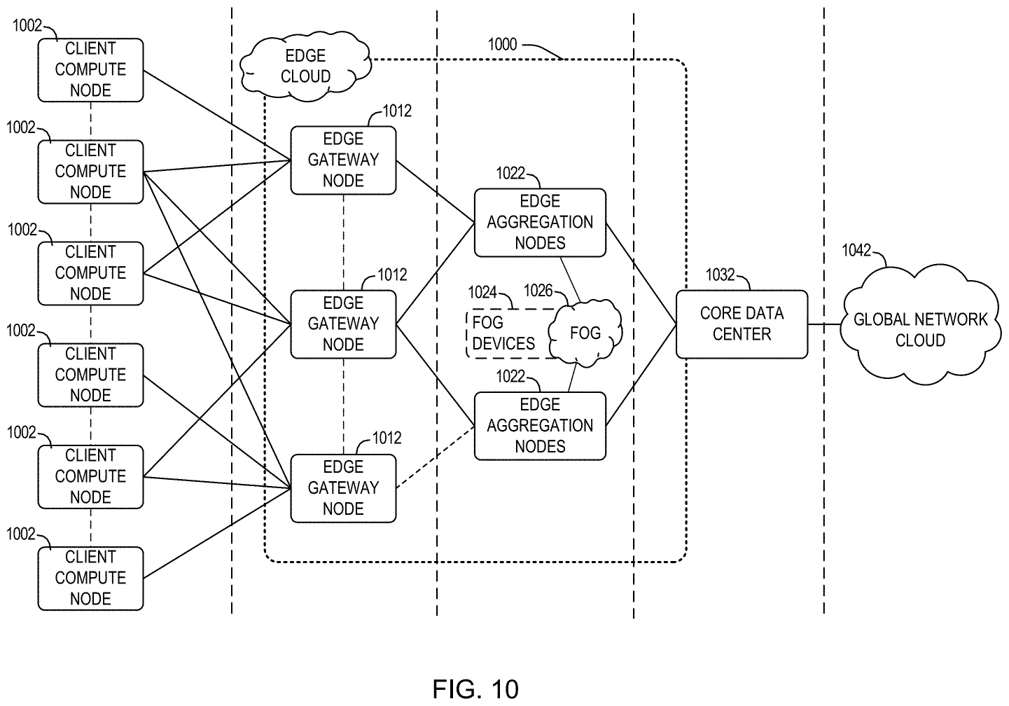

FIG. 10 generically depicts an edge computing system 1000 for providing edge services and applications to multi-stakeholder entities, as distributed among one or more client compute nodes 1002, one or more edge gateway nodes 1012, one or more edge aggregation nodes 1022, one or more core data centers 1032, and a global network cloud 1042, as distributed across layers of the network. The implementation of the edge computing system 1000 may be provided at or on behalf of a telecommunication service provider (“telco”, or “TSP”), internet-of-things service provider, cloud service provider (CSP), enterprise entity, or any other number of entities. Various implementations and configurations of the system 1000 may be provided dynamically, such as when orchestrated to meet service objectives.

For example, the client compute nodes 1002 are located at an endpoint layer, while the edge gateway nodes 1012 are located at an edge devices layer (local level) of the edge computing system 1000. Additionally, the edge aggregation nodes 1022 (and/or fog devices 1024, if arranged or operated with or among a fog networking configuration 1026) are located at a network access layer (an intermediate level). Fog computing (or “fogging”) generally refers to extensions of cloud computing to the edge of an enterprise's network or to the ability to manage transactions across the cloud/edge landscape, typically in a coordinated distributed or multi-node network. Some forms of fog computing provide the deployment of compute, storage, and networking services between end devices and cloud computing data centers, on behalf of the cloud computing locations. Some forms of fog computing also provide the ability to manage the workload/workflow level services, in terms of the overall transaction, by pushing certain workloads to the edge or to the cloud based on the ability to fulfill the overall service level agreement.

Fog computing in many scenarios provide a decentralized architecture and serves as an extension to cloud computing by collaborating with one or more edge node devices, providing the subsequent amount of localized control, configuration and management, and much more for end devices. Thus, some forms of fog computing provide operations that are consistent with edge computing as discussed herein; the edge computing aspects discussed herein are also applicable to fog networks, fogging, and fog configurations. Further, aspects of the edge computing systems discussed herein may be configured as a fog, or aspects of a fog may be integrated into an edge computing architecture.

The core data center 1032 is located at a core network layer (a regional or geographically-central level), while the global network cloud 1042 is located at a cloud data center layer (a national or world-wide layer). The use of “core” is provided as a term for a centralized network location—deeper in the network—which is accessible by multiple edge nodes or components; however, a “core” does not necessarily designate the “center” or the deepest location of the network. Accordingly, the core data center 1032 may be located within, at, or near the edge cloud 1000. Although an illustrative number of client compute nodes 1002, edge gateway nodes 1012, edge aggregation nodes 1022, edge core data centers 1032, global network clouds 1042 are shown in FIG. 10, it should be appreciated that the edge computing system 1000 may include additional devices or systems at each layer. Devices at a layer can be configured as peer nodes to each other and, accordingly, act in a collaborative manner to meet service objectives.

Consistent with the examples provided herein, a client compute node 1002 may be embodied as any type of endpoint component, device, appliance, or other thing capable of communicating as a producer or consumer of data. Further, the label “node” or “device” as used in the edge computing system 1000 does not necessarily mean that such node or device operates in a client or agent/minion/follower role; rather, one or more of the nodes or devices in the edge computing system 1000 refer to individual entities, nodes, or subsystems which include discrete or connected hardware or software configurations to facilitate or use the edge cloud 1000.

As such, the edge cloud 1000 is formed from network components and functional features operated by and within the edge gateway nodes 1012 and the edge aggregation nodes 1022. The edge cloud 1000 may be embodied as any type of network that provides edge computing and/or storage resources which are proximately located to radio access network (RAN) capable endpoint devices (e.g., mobile computing devices, IoT devices, smart devices, etc.), which are shown in FIG. 10 as the client compute nodes 1002. In other words, the edge cloud 1000 may be envisioned as an “edge” which connects the endpoint devices and traditional network access points that serves as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

In some examples, the edge cloud 1000 may form a portion of or otherwise provide an ingress point into or across a fog networking configuration 1026 (e.g., a network of fog devices 1024, not shown in detail), which may be embodied as a system-level horizontal and distributed architecture that distributes resources and services to perform a specific function. For instance, a coordinated and distributed network of fog devices 1024 may perform computing, storage, control, or networking aspects in the context of an IoT system arrangement. Other networked, aggregated, and distributed functions may exist in the edge cloud 1000 between the core data center 1032 and the client endpoints (e.g., client compute nodes 1002). Some of these are discussed in the following sections in the context of network functions or service virtualization, including the use of virtual edges and virtual services which are orchestrated for multiple stakeholders.

As discussed in more detail below, the edge gateway nodes 1012 and the edge aggregation nodes 1022 cooperate to provide various edge services and security to the client compute nodes 1002. Furthermore, because a client compute node 1002 may be stationary or mobile, a respective edge gateway node 1012 may cooperate with other edge gateway devices to propagate presently provided edge services, relevant service data, and security as the corresponding client compute node 1002 moves about a region. To do so, the edge gateway nodes 1012 and/or edge aggregation nodes 1022 may support multiple tenancy and multiple stakeholder configurations, in which services from (or hosted for) multiple service providers, owners, and multiple consumers may be supported and coordinated across a single or multiple compute devices.

A variety of security approaches may be utilized within the architecture of the edge cloud 1000. In a multi-stakeholder environment, there can be multiple loadable security modules (LSMs) used to provision policies that enforce the stakeholder's interests. Enforcement point environments could support multiple LSMs that apply the combination of loaded LSM policies (e.g., where the most constrained effective policy is applied, such as where if one or more of A, B or C stakeholders restricts access then access is restricted). Within the edge cloud 1000, each edge entity can provision LSMs that enforce the Edge entity interests. The Cloud entity can provision LSMs that enforce the cloud entity interests. Likewise, the various Fog and IoT network entities can provision LSMs that enforce the Fog entity's interests.

In these examples, services may be considered from the perspective of a transaction, performed against a set of contracts or ingredients, whether considered at an ingredient level or a human-perceivable level. Thus, a user who has a service agreement with a service provider, expects the service to be delivered under terms of the SLA. Although not discussed in detail, the use of the edge computing techniques discussed herein may play roles during the negotiation of the agreement and the measurement of the fulfillment of the agreement (to identify what elements are required by the system to conduct a service, how the system responds to service conditions and changes, and the like).

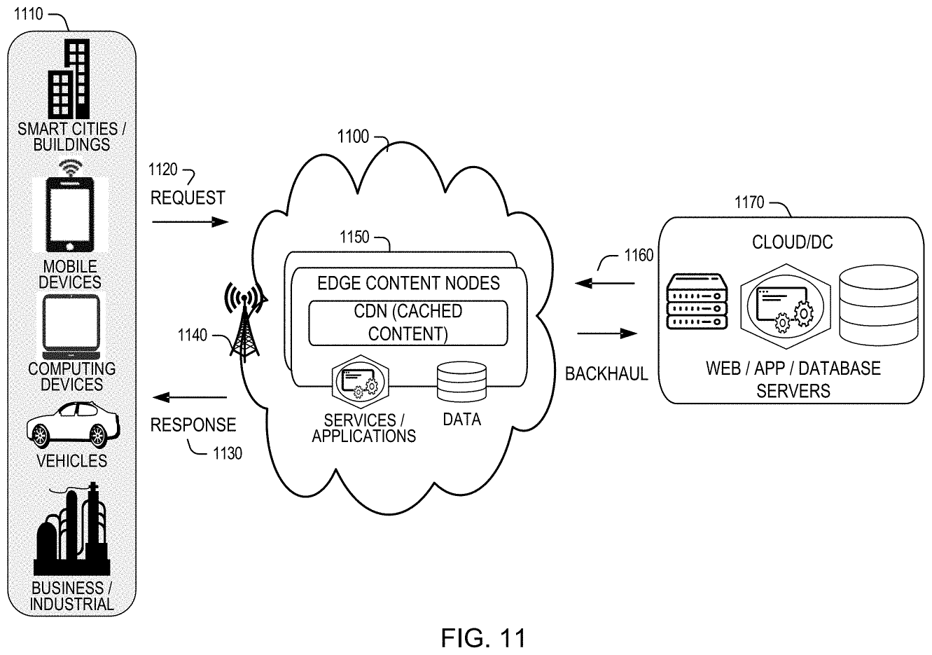

FIG. 11 shows an example where various client endpoints 1110 (in the form of mobile devices, computers, autonomous vehicles, business computing equipment, industrial processing equipment) provide requests 1120 for services or data transactions, and receive responses 1130 for the services or data transactions, to and from the edge cloud 1100 (e.g., via a wireless or wired network 1140). Within the edge cloud 1000, the CSP may deploy various compute and storage resources, such as edge content nodes 1150 to provide cached content from a distributed content delivery network. Other available compute and storage resources available on the edge content nodes 1150 may be used to execute other services and fulfill other workloads. The edge content nodes 1150 and other systems of the edge cloud 1000 are connected to a cloud or data center 1170, which uses a backhaul network 1160 to fulfill higher-latency requests from a cloud/data center for websites, applications, database servers, etc.

Various embodiments can use components described in one or more of FIGS. 1-11 in connection with allocating resources to execute any routine of a container in accordance with applicable SLAs, SLOs, or QoS. Various embodiments can use components described in one or more of FIGS. 1-11 in connection with attesting one or more routine of a container.

### Per-Component Attestation or Resource Allocation

Various cloud native containers may be subject to service level agreements (SLAs) that specify response time requirements and particular minimum resource allocations. However, containers can be composed of interdependent software entities (e.g., layers or components), and the software entities may be executed using different computing environments. In some cases, execution of a layer may impact performance of another layer, which can result in overall degradation of performance of the container and execution of the container potentially not complying with an applicable SLA. Various embodiments provide SLA specification and QoS enforcement on a per-container basis and per-layer basis. For example, various embodiments provide a manner for a developer to define for a layer, one or more of: attestation or validations requirements prior to execution of the layer; an SLA; or hardware, firmware, and/or software requirements to perform the layer.

Various embodiments can be used by cloud native stacks. In some embodiments, per-Docker layer SLA or Quality of Service (QoS) specification can be identified in current cloud native stacks or container images. For example, based on run-time criteria, QoS criteria may be specified and incorporated into a Docker layer, in addition to run-time selection aspects (e.g., choice of compression algorithm or target hardware allocation). For example, a compression algorithm can be chosen from various compression algorithms that have different tradeoffs between capacity (spatial savings) and compute required (compute savings). Per-Docker layer SLA awareness can potentially reduce uncertainty and variability in performance in shared resource usage environments. Various embodiments can be used by cloud service providers (CSPs), communications service providers, telecommunications services companies (e.g., TSPs), and/or virtual machine or container creation software.

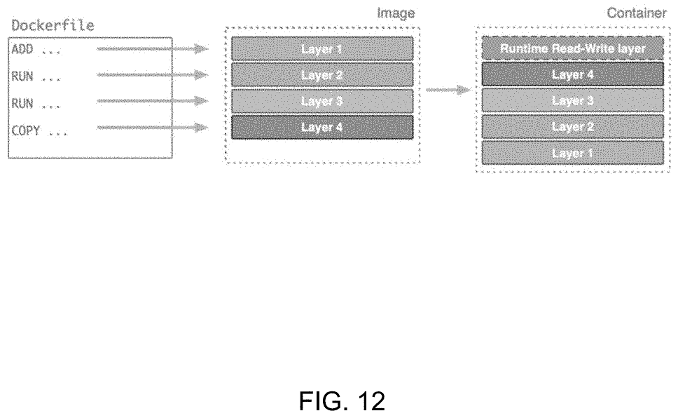

FIG. 12 depicts an example of a Docker container image. Docker is an open source software platform that allows a container to move from a first Docker computing environment to another computing environment with the same operating system (OS) and operate without changes, since the image includes dependencies to execute the code. Docker can use resource isolation features in an OS kernel to run multiple independent containers using a same OS.

A Docker image is a file, comprised of multiple layers, that is used to execute code in a Docker container. An image is built from the instructions for a complete and executable version of an application and relies on a host OS kernel. Layers (also called intermediate images) can be generated when the commands in a Docker file are executed during the Docker image build. Docker images can include read-only templates from which Docker containers are launched and an image can include a series of layers. A layer, or image layer can be a change of an image, or an intermediate image. A command (e.g., ADD, FROM, RUN, COPY, etc.) in a Docker file can cause the previous image to change, thus creating a new layer. Docker makes use of union file systems to combine these layers into a single image. Union file systems allow files and directories of separate file systems, known as branches, to be transparently overlaid, forming a single coherent file system.

A Docker Engine can compose a Docker image into a container. A Docker container can include an image with a readable/writeable layer on top of read-only layers. When Docker builds the container from a Docker file, an action corresponds to a command run in the Docker file. A layer can be made up of the file generated from running that command. A created layer is represented by its random generated ID. A Docker Engine can run at least on various Linux (e.g., CentOS, Debian, Fedora, Oracle Linux, RHEL, SUSE, and Ubuntu) and Windows Server operating systems.

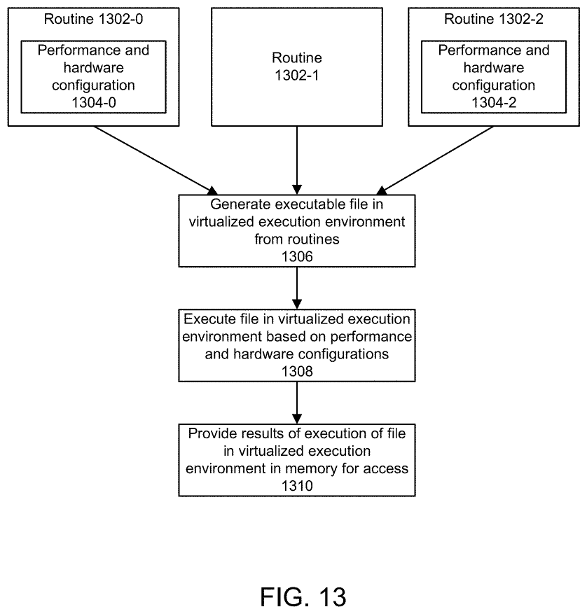

FIG. 13 depicts an example process in accordance with various embodiments. Routines or components 1302-0 to 1302-2 can be generated by a developer for execution by resources as described herein. Examples of routines 1302-0 to 1302-2 include one or more of: Docker layers, file system, subroutines, function calls, called code segments (e.g., API called code segments, RPC, gRPC), system calls, libraries, runtimes, function dependencies, binaries, device drivers, and/or operating system. Although routines 1302-0 to 1302-2 are shown, any number of routines can be used. Various embodiments can be used for container technologies, including but not limited to Docker containers, Rkt containers, LXD containers, OpenVZ containers, Linux-VServer, Windows Containers, Hyper-V Containers, unikernels, or Java containers, etc. Other virtual machine (VM) or container environments or workload deployment managers or engines or runtime or image inspection and distribution can be used such as: LXD for LXC (Linux containers), Hyper-V and Windows containers, rkt, Kubernetes, CRI-O, Podman open-source container engine, runC containers, containerd container runtime, Artifactory Docker registry, Buildah, Kaniko, buildkit, or runc.

Various examples of routines 1302-0 to 1302-2 can include performance and hardware configurations, whereas zero or more of the routines may not include performance and hardware configurations. For example, a routine can be executed as a microservice. For example, performance and hardware configurations can specify at least a time to complete the routine and hardware resources to allocate to perform the routine. In this example, routines 1302-0 and 1302-2 can include performance and hardware configurations 1304-0 and 1304-2 whereas routine 1302-1 does not include performance and hardware configurations. Routine 1302-1 can be executed best efforts in some examples but subject to an applicable SLA for the virtualized execution environment that includes routine 1302-1.

A virtualized execution environment (VEE) can include at least a virtual machine or a container. A virtual machine (VM) can be software that runs an operating system and one or more applications. A VM can be defined by specification, configuration files, virtual disk file, non-volatile random access memory (NVRAM) setting file, and the log file and is backed by the physical resources of a host computing platform. A VM can include an operating system (OS) or application environment that is installed on software, which imitates dedicated hardware. The end user has the same experience on a virtual machine as they would have on dedicated hardware. Specialized software, e.g., a hypervisor, can emulate the PC client or server's CPU, memory, hard disk, network and other hardware resources completely, enabling virtual machines to share the resources. The hypervisor can emulate multiple virtual hardware platforms that are isolated from each other, allowing virtual machines to run Linux®, Windows® Server, VMware ESXi, and other operating systems on the same underlying physical host. Examples of a hypervisor include Kernel-based Virtual Machine (KVM), VMware Workstation Pro, Xen Server, VMware vSphere, VMware ESXi, VMware Player, VMware Workstation, Microsoft Hyper-V, QEMU, VirtualBox, or Kubernetes.

A container can be a software package of applications, configurations and dependencies so the applications run reliably on one computing environment to another. Containers can share an operating system installed on the server platform and run as isolated processes. A container can be a software package that contains everything the software needs to run such as system tools, libraries, and settings. Containers are not installed like traditional software programs, which allows them to be isolated from the other software and the operating system itself. The isolated nature of containers provides several benefits. First, the software in a container will run the same in different environments. For example, a container that includes PHP and MySQL can run identically on both a Linux® computer and a Windows® machine. Second, containers provide added security since the software will not affect the host operating system. While an installed application may alter system settings and modify resources, such as the Windows registry, a container can only modify settings within the container. For example, containers can be implemented in various serverless or lightweight virtualization technologies such as Amazon Web Services (AWS) Firecracker. For example, an Amazon Lambda function can permit running code without provisioning or managing servers. Alternatives to Lambda include Azure App Service, Google App Engine, Cloud Foundry, and so forth.

In the following example routine, a Docker source code file includes performance and hardware configurations. Operations performed by a file can include machine learning training, machine learning (ML) inference, video processing, or encryption/decryption that can be executed in a cloud native environment, and so forth.

```
  FROM openvino/ubuntu18_runtime:2020.4
  ENV DEBIAN_FRONTEND noninteractive
  ARG LICENSE_SERVER_ADDRESS
  USER root
  #COMMON - Network and Host
  DOCKER START LAYER ATTESTATION LAYERTYPE=SECURITY
  ARG TEMP_DIR=/root/installation
  ARG SURVELLIANCE=survelliancecpuapi_v2.5.2.941
  run mkdir $TEMP_DIR
  COPY $SURVELLIANCE.tar.gz* $TEMP_DIR
  WORKDIR $TEMP_DIR
  DOCKER LAYER SELECTION LAYERTYPE= SECURITY
  SLO1=10 FPS
  SLO2=10ms RESERVE HARWARE RESOURCES
  (4 CPU cores, 100 Mbs memory bandwidth)
  RUN tar xvfz $SURVELLIANCE.tar.gz
  COPY run.sh /root/installation/survelliancecpuapi/samples
  RUN chmod 770 /root/installation/survelliancecpuapi/samples/run.sh
  DOCKER END LAYER ATTESTATION LAYERTYPE=SECURITY
  #COMMON - Network and Host
  ARG LIBS=“gdb vim wget bc libboost-dev libboost-all-dev”
  RUN apt update && \
    apt install -y --no-install-recommends sudo $LIBS && \
    rm -rf /var/lib/apt/lists/* && \
    rm -Rf /var/cache/apt && \
    echo “%openvino ALL=(ALL) NOPASSWD:/etc/init.d/aksusbd
restart” >>
  /etc/sudoers
  COPY run.sh /root/installation/survelliancecpuapi/bin
  RUN cp /root/installation/survelliancecpuapi/lib/*
  /root/installation/survelliancecpuapi/bin
  WORKDIR /root/installation/survelliancecpuapi/bin
  RUN cat run.sh
  USER root
CMD [“/root/installation/survelliancecpuapi/samples/run.sh”]
```

In this example, statement “DOCKER LAYER SELECTION LAYERTYPE=SECURITY SLO1=10 FPS (frames per second) SLO2=10 ms” can indicate a service level objective (SLO) of completing 10 frames per second and a second service level objective of completing the routine in 10 ms. In this example, statement “RESERVE HARWARE RESOURCES (4 CPU cores, 100 Mbs memory bandwidth)” can indicate request reservation of 4 CPU cores and 100 Mbps memory bandwidth for the routine. Other syntaxes and other expressions can be used to specify per-routine SLO and hardware resources. Other examples of specification of SLO, SLA, and hardware resources to reserve can be used. For example, time to completion of a routine can be specified. The statements can represent a minimum resource reservation request such that even more resources can be allocated to perform the routine.

At 1306, an executable file in a virtualized execution environment can be generated from the routines. For example, a Docker image can be generated for execution in a container. In some examples, where routine attestation or validation is to be performed, validation of the layer can be performed as a condition to inclusion of the routine in a file. For example, a Docker layer can be attested by communication with an attestation entity (e.g., server) and if the layer is attested, the layer can be included in the Docker image and container. If the layer is not attested, the layer is not to be used in the Docker image or container.

At 1308, the executable file can be executed in a virtualized execution environment at least on specified hardware devices or to meet or exceed specified SLO specifications associated with a routine. For example, the executable file can be dispatched for execution in a container at least on specified hardware devices or to meet or exceed specified SLO specifications. Where the executable file is a Docker image, the Docker image can be executed as a Docker container at least on specified hardware devices or to meet or exceed SLO specifications. For example, to meet or exceed specified SLO specifications, hardware, firmware, and/or software can be selected for use to perform a routine with a specified hardware device or SLO specification. In some examples, a Docker Engine can be configured to support dispatch of a Docker container and, for a routine with a specified hardware device or SLO specification, to utilize specified hardware devices or to meet or exceed SLO specifications. In some examples, a hypervisor or orchestrator could allocate resources to meet per-layer SLO and enforce per-layer SLO. In addition, container-level SLA or SLO and hardware, firmware, and/or software specification can be applied to satisfy an overall container SLA or SLO and hardware, firmware, and/or software specification. Accordingly, per-routine and per-container performance and hardware, firmware, and/or software specifications can be applied.

In some examples, as described herein, hardware, firmware, and/or software can be selected for use to perform a routine with a specified hardware device or SLO specification based on learned performance of available hardware and/or software. For example, if an amount or level of hardware and/or software resources is determined to not provide specified SLA or SLO requirements based on history, additional hardware, firmware, and/or software resources can be made available for performance of a routine or its larger file.

At 1310, results of the execution of the file can be made available in memory for access. For example, a requester can access the results of the execution of the routine and file. The requester can include a service in a service chain, a client device, a client application, an application, or others.

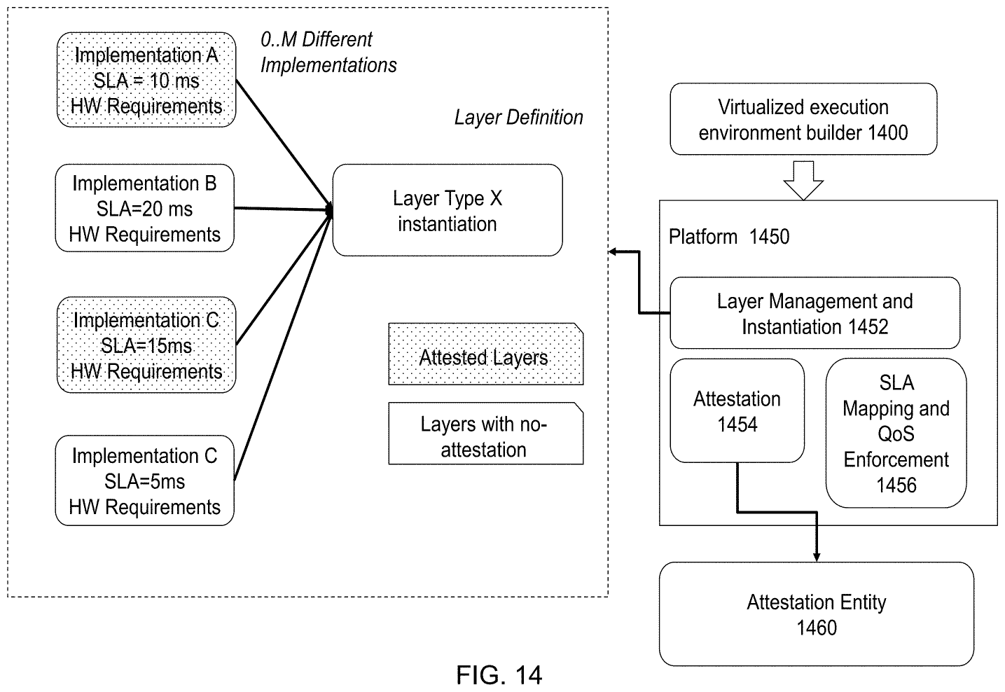

FIG. 14 depicts a high-level architectural diagram. Various embodiments provide an architecture that allows instantiation of routines within a file that can be executed in a virtualized execution environment to achieve applicable quality of service per-routine and security per-routine. Some embodiments provide for specification of the following meta-data for a routine: (1) security meta-data or (2) QoS meta-data. A security meta-data can indicate whether the particular routine needs to be attested before being loaded into a file. A QoS meta-data can indicate whether the particular routine has associated performance or hardware, firmware, and/or software requirements. For example, the security meta-data and QoS meta-data can be included in source code of a layer. For example, certain types of routines can be standardized in terms of what they perform (e.g., image segmentation, image processing, image recognition, or inference,) and the service level objectives to achieve (e.g., frames per second, latency, accuracy, etc.) and in such cases, a routine type can be declared in a definition along with specifying one or multiple QoS.

For example, when a virtualized execution environment builder 1400 creates as virtualized execution environment from one or more routines, security and QoS meta-data for one or more routines can be considered to determine whether to include a routine and what resources to allocate to execute the routine. In some examples, virtualized execution environment builder 1400 includes a Docker Engine that creates a Docker container from one or more layers and at least one layer specifies attestation requirements, QoS, SLA, SLO, COS, and hardware resources. A layer can identify its particular type such that the layer can be subject to particular SLA and allocated certain resources.

Layer management and instantiation 1452 can for manage the routines, for example, determining when a routine is to be initialized and the ordering between routines, etc. If the routine is identified to be attested, or one or more routines are to be attested regardless of whether the routine is identified to be attested, before committing the routine (e.g., downloading and installing a library), virtualized execution environment builder 1400 can create a temporal instance of the routine and use attestation circuitry 1454 to perform the attestation. Attestation, in some examples, can perform a hash computation on a portion of a numerical representation of a routine and communicate with an attestation entity 1460 to perform attestation for the routine. Attestation, in some examples, a routine can identify a source of the routine and attestation can include determining if the source is a trusted source. Attestation entity 1460 can include a trusted entity on platform 1450 or a server connected with platform 1450 using a secure link. If the routine is validated, it is committed to the virtualized execution environment. If routine is not validated, other than not committing the routine, a user or administrator could be notified and asked to select an action, or other pre-defined actions can be taken, such as abort container build, etc.

If a routine specifies a certain type of SLO, virtualized execution environment builder 1400 can access SLA mapping and QoS enforcement circuitry 1456 to map the provided routine or layer type and the SLO required with the various resources available in platform 1450. SLA mapping and QoS enforcement circuitry 1456 can allow virtualized execution environment builder 1400 to reserve resource proactively after virtualized execution environment composition. Resources (not depicted) can include one or more of: number of CPU cores, uncore frequency, XPU resources, GPU resources, NVIDIA Multi-Instance GPU (MIG) resources, address memory amounts, memory bandwidth, cache allocation (e.g., L1, L2, L3, last level cache (LLC)), storage allocation amounts, accelerator allocation, network interface controller bandwidth, and so forth. Resources can be available in a server, rack, row, data center, edge server, or distributed as a composite node in accordance with examples described herein.

SLA mapping and QoS enforcement 1456 can create a virtual process address space identifier (PASID) to identify a virtualized execution environment or virtualized execution environment routine and identify what resources perform the virtualized execution environment or virtualized execution environment routine. The virtual PASID can be provided to a system software stack (e.g., hypervisor and/or OS) to identify a virtualized execution environment. SLA mapping and QoS enforcement 1456 can re-map the virtual PASID resources to one or more real PASIDS for the virtualized execution environment instance.

For example, SLA mapping and QoS enforcement 1456 can provide allocation of resources for a routine in a virtualized execution environment such as cache allocation, memory allocation, memory bandwidth (e.g., rate at which data can be read from or stored into a memory device by a virtualized execution environment), accelerator usage, processor usage, or other features. For example, SLA mapping and QoS enforcement 1456 can access or utilize a resource manager such as Intel® resource director technology (RDT) or AMD Platform quality of service (QoS) to allocate resources for routines of a virtualized execution environment. For example, access to resource manager can be made based on writes-to or reads-from Model-Specific Registers (MSRs). A resource manager can provide one or more of: Cache Allocation Technology (CAT), Code and Data Prioritization (CDP), Memory Bandwidth Allocation (MBA), Cache Monitoring Technology (CMT), and Memory Bandwidth Monitoring (MBM).

For example, CAT can provide configuration of cache capacity for a routine or virtualized execution environment such as LLC. For example, CDP can provide separate control over code and data placement in the last-level (L3) cache. For example, cache locking (e.g., exclusive allocation of a cache (e.g., L1, L2, L3, system cache, last level cache (LLC))) can be performed. For example, MBA can provide control over memory bandwidth available to workloads. Memory bandwidth can represent a rate at which data can be read from or stored into a memory device or storage device by a processor. For example, CMT can provide monitoring of last-level cache (LLC) utilization by individual threads, applications, or virtualized execution environments. CMT can enable tracking of the L3 cache occupancy, enabling detailed profiling and tracking of threads, applications, or virtualized execution environments. CMT can enables resource-aware scheduling decisions, aid in “noisy neighbor” detection and assist with performance debugging. For example, MBM can provide event reporting of local and remote memory bandwidth. Reporting local memory bandwidth can include a report of bandwidth of a thread accessing memory. In a dual socket system, the remote memory bandwidth can include a report the bandwidth of a thread accessing the remote socket. For example, MBM can provide monitoring of multiple virtualized execution environments, or applications independently, which can provide memory bandwidth monitoring for one or more running thread simultaneously.

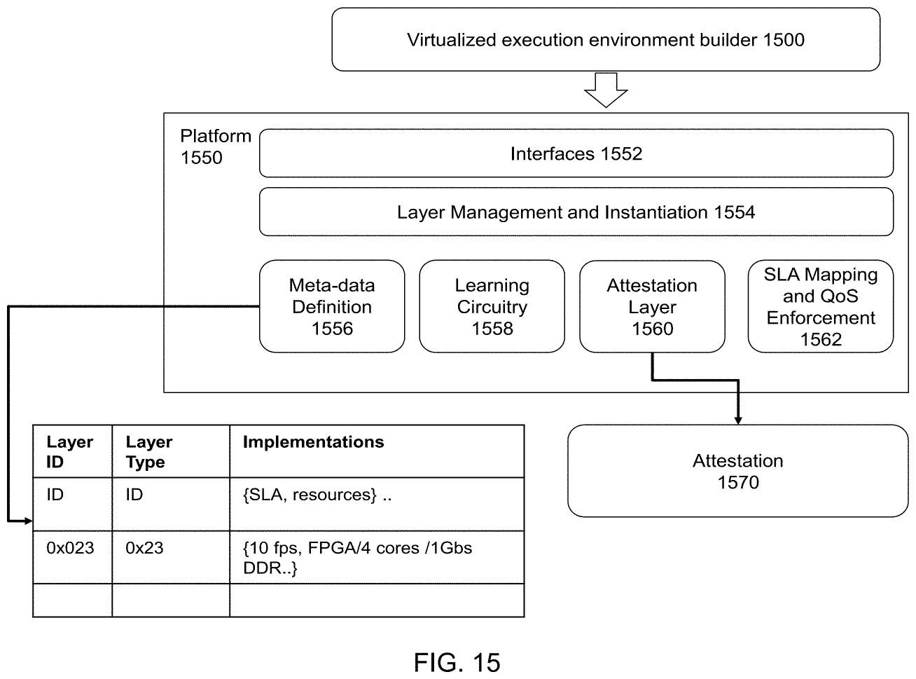

FIG. 15 depicts an example system. Interfaces 1552 to platform 1550 can be utilized by virtualized execution environment builder 1500 to allow indication that a particular routine that has been instantiated in a temporal space (e.g., memory range) that is to be attested or subject to an SLA; SLO; COS; or hardware, firmware, and/or software requirement. A Docker implementation can provide to interfaces 1552 one or more of: location of the temporal space of the layer, type of layer, size of the layer, and type of attestation. A type of attestation can identify a source of the layer and request to perform attestation. Interfaces 1552 can allow an SLA to be attached to that layer based on a type of layer, if an SLA or hardware resources are not specified by the layer.

SLA Mapping and QoS enforcement 1456 can select a layer or routine type for a layer or routine that defines an SLA and the resources to execute such layer or routine. SLA Mapping and QoS enforcement 1456 can allocate resources to execute a layer or routine and enforce allocation of resources for performance of the layer or routine. Meta-data definitions 1556 can be accessed to identify whether particular layer or routine type has certain applicable SLA and hardware, firmware, or software allocations. For example, for a particular layer type, an SLO can include at least one SLO metric value to achieve (e.g., frames per second, time to completion, error rate, etc.) as well as resources to allocate to perform the routine or layer.

For example, FIG. 15 depicts an example of a layer type of 0x23 that provides 10 frames per second (fps) performance and resources of an FPGA accelerator, 4 cores and 1 Gbps DDR memory. Other performance and resource parameters can be specified for other type identifiers. If multiple layer types are available for association with a layer or routine type, SLA Mapping and QoS enforcement 1562 can select a layer type based on resource utilization such that less utilized resources are used to execute the layer or routine to reduce likelihood that the resource is not executed in accordance with its applicable SLA. In some examples, for lower CPU availability and high available memory capacity, data compression may not be applied, or lightweight compression can be applied to reduce use of CPU resources in performing compression. The converse can be also applied, for example, if CPU resources are readily available but memory capacity is low, compression can be applied to use less available memory.

SLA Mapping and QoS enforcement 1562 can create a virtual PASID for the virtualized execution environment, identify resources allocated to the virtualized execution environment to the virtual PASID, and provide the virtual PASID to a software stack. A virtual PASID can used by the software stack as an identifier of which routine or layer is dispatched for execution and which resources are used to perform the routine or layer.

For example, attestation circuitry 1560 may validate one or more routines of a virtualized execution environment and indicate to virtualized execution environment builder 1500 whether a routine was attested or validated. Attestation circuitry 1560 can be used where there is an operation that requires accessing sensitive data in that routine to verify no malicious interception of that layer is has occurred before sensitive data is exposed.

For example, where virtualized execution environment builder 1500 includes a Docker Engine, a Docker Engine can create a temporal instance of a layer and request attestation circuitry 1560 to perform the attestation. Attestation circuitry 1560 can attest a temporal instance of a layer, create a hash of a portion of a numerical version of the temporal layer, connect to attestation entity 1570, and provide the hash and request attestation by attestation entity 1570. Attestation entity 1570 can indicate whether the layer is attested or not. If the layer is attested or not attested, attestation layer logic can respond to the Docker Engine with an indication of the attestation result. Based on the attestation result, the Docker Engine can determine to include the attested layer in a container image or not include the unattested image in the container image. The attestation of the layers can be validated before the Docker Engine commits the layer to a container (e.g., downloading and installing a library).

Learning circuitry 1558 may be used to learn performance of various layer types over time and improve resource allocation in meta-data definitions 1556. For example, learning circuitry 1558 can learn that execution of a layer does not meet SLO goals using previously allocated resources and can allocate other resources in meta-data definitions 1556 for use to perform the layer or cause the layer to be migrated for execution on other resources to achieve the SLO even during execution of the layer.

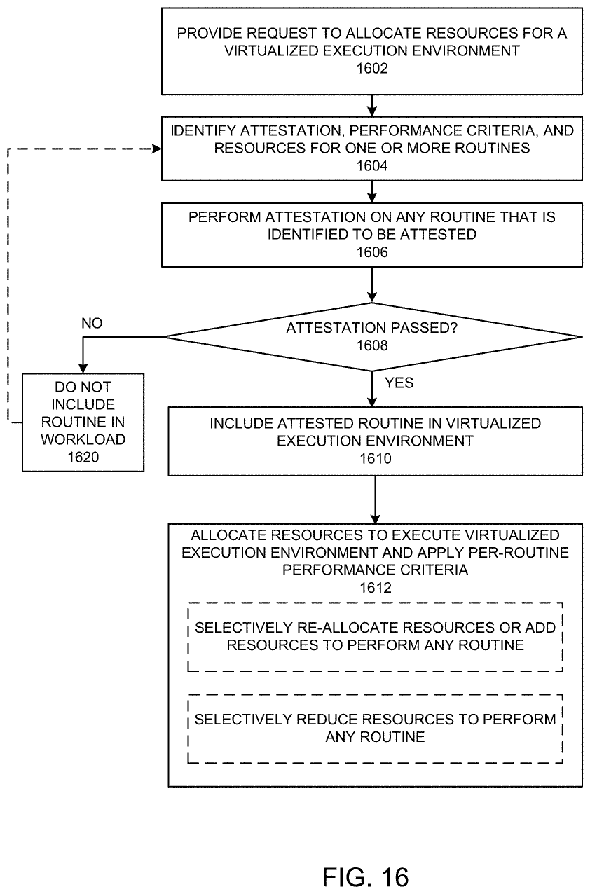

FIG. 16 depicts an example process. For example, the process can be performed by a virtualized execution environment creation engine in communication with a resource manager. At 1602, a request to allocate hardware, firmware, and/or software resources to a virtualized execution environment can be provided to a platform via one or more interfaces. The platform can include a resource manager, orchestrator, hypervisor, or other circuitry to allocate resources to the virtualized execution environment. In some examples, the platform can also cause execution of the virtualized execution environment on selected resources. The virtualized execution environment can include a file with one or more routines. In some examples, the virtualized execution environment includes one or more of: Docker containers, Rkt containers, LXD containers, OpenVZ containers, Linux-VServer, Windows Containers, Hyper-V Containers, unikernels, or Java containers. For example, a routine can include one or more of: Docker layers, file system, subroutines, function calls, called code segments (e.g., API called code segments, RPC, gRPC), system calls, libraries, runtimes, function dependencies, binaries, device drivers, operating system, and/or others.

At 1604, the platform can identify application attestation requirements, performance criteria or resource allocations specified for one or more routines of the virtualized execution environment. For example, the routine can indicate whether the routine is to be attested or validated. In some examples, based on a type of the routine, the resource manager can determine to attest or validate the routine. To indicate performance criteria or resource allocation, at least one routine can indicate application of an SLA, SLO, or QoS or identify a particular routine type. In some examples, source code of a routine can indicate an SLA, SLO, or QoS that indicates a particular performance requirement and requested hardware, firmware, and/or software resources. In some examples, source code of a routine can indicate a routine type and a resource manage can determine applicable SLA, SLO, or QoS and hardware resources to allocate to perform the routine based on the routine type.

At 1606, attestation can be performed of a routine that is to be attested. In some examples, attestation is performed on a routine that includes an indication to perform routine attestation. In some examples, one or more routines are attested whether or not a routine identifies itself as to be attested. For example, the routine can be attested by communicating with a server or local trusted entity and determining if properties of the routine are acceptable or match expected parameters. Properties can include a hash value generated from hashing a portion or entirety of the routine. The hash value can be compared against a value to determine if the routine is attested. For example, a temporal instance of a Docker layer can be generated, and attestation is performed on the temporal instance.

At 1608, a determination can be made if attestation of the routine passes. If attestation of the routine passes, the process can continue to 1610. If attestation of the routine fails, the process can continue to 1620.

At 1610, an attested routine can be allowed to be included in the virtualized execution environment. In some examples, a routine that is not subject to an attestation check can be included in the virtualized execution environment. At 1612, a resource manager can allocate local or distributed resources to perform one or more routines included in the virtualized execution environment. A routine with an SLA requirement or resource requirement can be allocated to be performed on resources to attempt to satisfy the SLA or resource requirement. In some examples, a table of resource allocation can be accessed based on a type of routine that is subject to an SLA requirement and the resource allocation is made based on a specific type of routine that is subject to an SLA requirement. Thereafter, the routines can be dispatched for execution by the selected resources. In some examples, based on identification of a routine failing its SLA requirements, different or additional resources can be allocated to perform routines of the virtualized execution environment to attempt to meet or exceed SLA requirements. In some examples, based on identification of performance of a routine exceeding its SLA requirements, resources can be de-allocated to perform a routine of the virtualized execution environment in order to free resources for other uses.

At 1620, based on the routine not being attested, the non-attested routine can be denied from inclusion in the workload. An error message can be provided to an administrator. In some examples, the virtualized execution environment is not permitted to be executed and the process can exit. The process can return to 1604 to perform attestation and resource allocation for another routine.

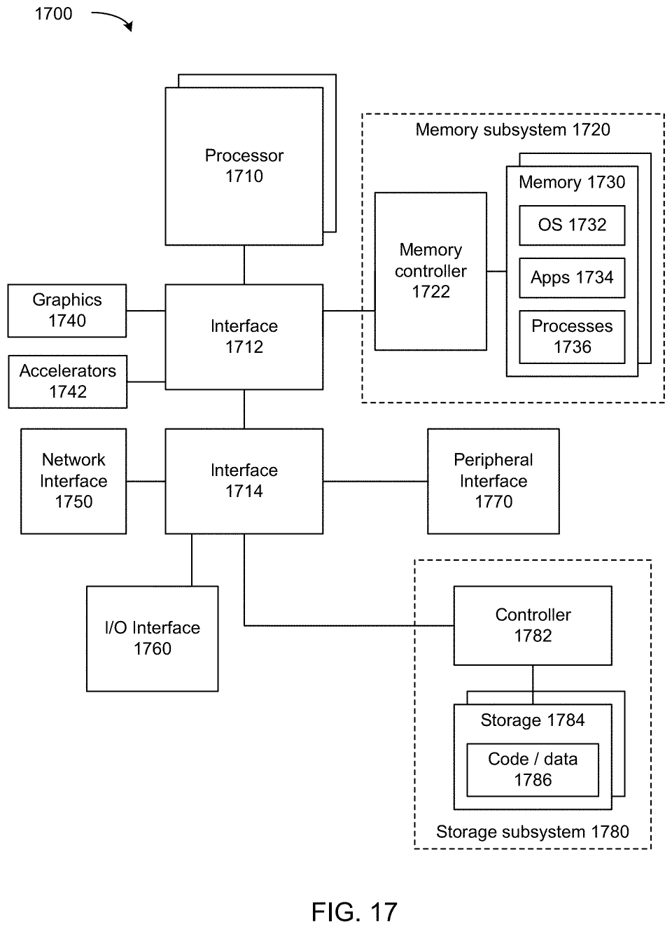

FIG. 17 depicts an example computing system. Various embodiments can be used by system 1700 to perform attestation and resource allocation on a per-routine basis. System 1700 includes processor 1710, which provides processing, operation management, and execution of instructions for system 1700. Processor 1710 can include any type of microprocessor, central processing unit (CPU), graphics processing unit (GPU), processing core, or other processing hardware to provide processing for system 1700, or a combination of processors. Processor 1710 controls the overall operation of system 1700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1700 includes interface 1712 coupled to processor 1710, which can represent a higher speed interface or a high throughput interface for system components that needs higher bandwidth connections, such as memory subsystem 1720 or graphics interface components 1740, or accelerators 1742. Interface 1712 represents an interface circuit, which can be a standalone component or integrated onto a processor die. Where present, graphics interface 1740 interfaces to graphics components for providing a visual display to a user of system 1700. In one example, graphics interface 1740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1740 generates a display based on data stored in memory 1730 or based on operations executed by processor 1710 or both. In one example, graphics interface 1740 generates a display based on data stored in memory 1730 or based on operations executed by processor 1710 or both.

Accelerators 1742 can be a fixed function or programmable offload engine that can be accessed or used by a processor 1710. For example, an accelerator among accelerators 1742 can provide compression (DC) capability, cryptography services such as public key encryption (PKE), cipher, hash/authentication capabilities, decryption, or other capabilities or services. In some embodiments, in addition or alternatively, an accelerator among accelerators 1742 provides field select controller capabilities as described herein. In some cases, accelerators 1742 can be integrated into a CPU socket (e.g., a connector to a motherboard or circuit board that includes a CPU and provides an electrical interface with the CPU). For example, accelerators 1742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 1742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1720 represents the main memory of system 1700 and provides storage for code to be executed by processor 1710, or data values to be used in executing a routine. Memory subsystem 1720 can include one or more memory devices 1730 such as read-only memory (ROM), flash memory, one or more varieties of random access memory (RAM) such as DRAM, or other memory devices, or a combination of such devices. Memory 1730 stores and hosts, among other things, operating system (OS) 1732 to provide a software platform for execution of instructions in system 1700. Additionally, applications 1734 can execute on the software platform of OS 1732 from memory 1730. Applications 1734 represent programs that have their own operational logic to perform execution of one or more functions. Processes 1736 represent agents or routines that provide auxiliary functions to OS 1732 or one or more applications 1734 or a combination. OS 1732, applications 1734, and processes 1736 provide software logic to provide functions for system 1700. In one example, memory subsystem 1720 includes memory controller 1722, which is a memory controller to generate and issue commands to memory 1730. It will be understood that memory controller 1722 could be a physical part of processor 1710 or a physical part of interface 1712. For example, memory controller 1722 can be an integrated memory controller, integrated onto a circuit with processor 1710.

In some examples, OS 1732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 1700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1700 includes interface 1714, which can be coupled to interface 1712. In one example, interface 1714 represents an interface circuit, which can include standalone components and integrated circuitry. In one example, multiple user interface components or peripheral components, or both, couple to interface 1714. Network interface 1750 provides system 1700 the ability to communicate with remote devices (e.g., servers or other computing devices) over one or more networks. Network interface 1750 can include an Ethernet adapter, wireless interconnection components, cellular network interconnection components, USB (universal serial bus), or other wired or wireless standards-based or proprietary interfaces. Network interface 1750 can transmit data to a device that is in the same data center or rack or a remote device, which can include sending data stored in memory. Network interface 1750 can receive data from a remote device, which can include storing received data into memory. Various embodiments can be used in connection with network interface 1750, processor 1710, and memory subsystem 1720. Various embodiments of network interface 1750 use embodiments described herein to receive or transmit timing related signals and provide protection against circuit damage from misconfigured port use while providing acceptable propagation delay.

In one example, system 1700 includes one or more input/output (I/O) interface(s) 1760. I/O interface 1760 can include one or more interface components through which a user interacts with system 1700 (e.g., audio, alphanumeric, tactile/touch, or other interfacing). Peripheral interface 1770 can include any hardware interface not specifically mentioned above. Peripherals refer generally to devices that connect dependently to system 1700. A dependent connection is one where system 1700 provides the software platform or hardware platform or both on which operation executes, and with which a user interacts.

In one example, system 1700 includes storage subsystem 1780 to store data in a nonvolatile manner. In one example, in certain system implementations, at least certain components of storage 1780 can overlap with components of memory subsystem 1720. Storage subsystem 1780 includes storage device(s) 1784, which can be or include any conventional medium for storing large amounts of data in a nonvolatile manner, such as one or more magnetic, solid state, or optical based disks, or a combination. Storage 1784 holds code or instructions and data 1786 in a persistent state (i.e., the value is retained despite interruption of power to system 1700). Storage 1784 can be generically considered to be a “memory,” although memory 1730 is typically the executing or operating memory to provide instructions to processor 1710. Whereas storage 1784 is nonvolatile, memory 1730 can include volatile memory (i.e., the value or state of the data is indeterminate if power is interrupted to system 1700). In one example, storage subsystem 1780 includes controller 1782 to interface with storage 1784. In one example controller 1782 is a physical part of interface 1714 or processor 1710 or can include circuits or logic in both processor 1710 and interface 1714.

A volatile memory is memory whose state (and therefore the data stored in it) is indeterminate if power is interrupted to the device. Dynamic volatile memory uses refreshing the data stored in the device to maintain state. One example of dynamic volatile memory includes DRAM (Dynamic Random Access Memory), or some variant such as Synchronous DRAM (SDRAM). An example of a volatile memory include a cache. A memory subsystem as described herein may be compatible with a number of memory technologies, such as DDR3 (Double Data Rate version 3, original release by JEDEC (Joint Electronic Device Engineering Council) on Jun. 16, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of one or more of the above, or other memory.

A power source (not depicted) provides power to the components of system 1700. More specifically, power source typically interfaces to one or multiple power supplies in system 1700 to provide power to the components of system 1700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Embodiments herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade can include components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, edge servers, edge switches, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or combination thereof, including “X, Y, and/or Z.”

Illustrative examples of the devices, systems, and methods disclosed herein are provided below. An embodiment of the devices, systems, and methods may include one or more, and combination of, the examples described below.

Example 1 includes a method comprising: for a routine in a group of routines within a container, allocating hardware resources from a group of hardware resources based on performance goals associated with the routine.

Example 2 includes one or more examples, wherein the routine comprises layer of a Docker container.

Example 3 includes one or more examples, wherein the performance goals comprise time to completion of the routine.

Example 4 includes one or more examples, wherein source code of the routine includes specification of the performance goals.

Example 5 includes one or more examples, wherein the group of hardware resources comprise one or more of: cache allocation, memory allocation, memory bandwidth, network interface bandwidth, or accelerator allocation.

Example 6 includes one or more examples, wherein the routine includes meta-data that indicates whether the routine is to be attested before being loaded into the group of routines.

Example 7 includes one or more examples, and includes attesting the routine as at least one condition to adding the routine to the group of routines.

Example 8 includes one or more examples, and includes determining a type of the routine and allocating resources to the routine based on its type.

Example 9 includes one or more examples, and includes an apparatus comprising: at least one processor to: perform a command to build a container using multiple routines and allocate resources to at least one routine based on specification of a service level agreement (SLA) associated with each of the at least one routine.

Example 10 includes one or more examples, wherein the container is compatible with one or more of: Docker containers, Rkt containers, LXD containers, OpenVZ containers, Linux-VServer, Windows Containers, Hyper-V Containers, unikernels, or Java containers.

Example 11 includes one or more examples, wherein the at least one processor comprises one or more of: Intel® resource director technology (RDT) or AMD Platform quality of service (QoS).

Example 12 includes one or more examples, wherein service level is to specify one or more of: time to completion of a routine or resource allocation to the routine.

Example 13 includes one or more examples, wherein the resources comprise one or more of: cache allocation, memory allocation, memory bandwidth, network interface bandwidth, or accelerator allocation.

Example 14 includes one or more examples, wherein the at least one processor is to validate a routine as at least one condition to adding the routine to the container.

Example 15 includes one or more examples, and includes a computer-readable medium comprising instructions stored thereon, that if executed by one or more processors, cause the one or more processors to: perform a container build operation to form a container from one or more routines and request allocation of hardware resources to perform at least one routine based on associated service level objective (SLO) parameters.

Example 16 includes one or more examples, wherein the container is compatible with one or more of: Docker containers, Rkt containers, LXD containers, OpenVZ containers, Linux-VServer, Windows Containers, Hyper-V Containers, unikernels, or Java containers.

Example 17 includes one or more examples, wherein the request allocation of hardware resources is provided to one or more of: Intel® resource director technology (RDT) or AMD Platform QoS.

Example 18 includes one or more examples, wherein the SLO parameters are to specify one or more of: time to completion of a routine or resource allocation to the routine.

Example 19 includes one or more examples, wherein the resources comprise one or more of: cache allocation, memory allocation, memory bandwidth, network interface bandwidth, or accelerator allocation.

Example 20 includes one or more examples, wherein a Docker Engine is to perform a container build operation to form a container from one or more routines and request allocation of hardware resources to perform at least one routine based on associated service level objective (SLO) parameters.

1. A method comprising:
for a routine in a group of routines within a container, allocating hardware resources from a group of hardware resources based on performance goals associated with the routine.

2. The method of claim 1, wherein the routine comprises layer of a Docker container.

3. The method of claim 1, wherein the performance goals comprise time to completion of the routine.

4. The method of claim 1, wherein source code of the routine includes specification of the performance goals.

5. The method of claim 1, wherein the group of hardware resources comprise one or more of: cache allocation, memory allocation, memory bandwidth, network interface bandwidth, or accelerator allocation.

6. The method of claim 1, wherein the routine includes meta-data that indicates whether the routine is to be attested before being loaded into the group of routines.

7. The method of claim 1, comprising attesting the routine as at least one condition to adding the routine to the group of routines.

8. The method of claim 1, comprising determining a type of the routine and allocating resources to the routine based on its type.

9. An apparatus comprising:
at least one processor to:
perform a command to build a container using multiple routines and
allocate resources to at least one routine based on specification of a service level agreement (SLA) associated with each of the at least one routine.

10. The apparatus of claim 9, wherein the container is compatible with one or more of: Docker containers, Rkt containers, LXD containers, OpenVZ containers, Linux-VServer, Windows Containers, Hyper-V Containers, unikernels, or Java containers.

11. The apparatus of claim 9, wherein the at least one processor comprises one or more of: Intel® resource director technology (RDT) or AMD Platform quality of service (QoS).

12. The apparatus of claim 9, wherein service level is to specify one or more of: time to completion of a routine or resource allocation to the routine.

13. The apparatus of claim 9, wherein the resources comprise one or more of: cache allocation, memory allocation, memory bandwidth, network interface bandwidth, or accelerator allocation.

14. The apparatus of claim 9, wherein the at least one processor is to validate a routine as at least one condition to adding the routine to the container.

15. A computer-readable medium comprising instructions stored thereon, that if executed by one or more processors, cause the one or more processors to:
perform a container build operation to form a container from one or more routines and
request allocation of hardware resources to perform at least one routine based on associated service level objective (SLO) parameters.

16. The computer-readable medium of claim 15, wherein the container is compatible with one or more of: Docker containers, Rkt containers, LXD containers, OpenVZ containers, Linux-VServer, Windows Containers, Hyper-V Containers, unikernels, or Java containers.

17. The computer-readable medium of claim 15, wherein the request allocation of hardware resources is provided to one or more of: Intel® resource director technology (RDT) or AMD Platform QoS.

18. The computer-readable medium of claim 15, wherein the SLO parameters are to specify one or more of: time to completion of a routine or resource allocation to the routine.

19. The computer-readable medium of claim 15, wherein the resources comprise one or more of: cache allocation, memory allocation, memory bandwidth, network interface bandwidth, or accelerator allocation.

20. The computer-readable medium of claim 15, wherein a Docker Engine is to perform a container build operation to form a container from one or more routines and request allocation of hardware resources to perform at least one routine based on associated service level objective (SLO) parameters.
